(19) United States
(12) Patent Application Publication
(10) Pub. No.: US 2011/0011715 A1
(43) Pub. Date: Jan. 20, 2011

(54) SWITCH MECHANISM AND ELECTRONIC DEVICE

(75) Inventors: Takashi Itou, Tokyo (JP); Takaaki Yoshihiro, Tokyo (JP)

Correspondence Address: YOUNG & THOMPSON, 209 Madison Street, Suite 500, Alexandria, VA, 22314, US

(73) Assignee: NEC CORPORATION, TOKYO (JP)

(21) Appl. No.: 12/919,867

(22) PCT Filed: Mar. 2, 2009
(86) PCT No.: PCT/JP2009/053846

§ 371 Date: Aug. 27, 2010

(30) Foreign Application Priority Data
Mar. 6, 2008 (JP) 2008-056536

(51) Int. Cl. H01H 1/10; H01H 13/14

(52) U.S. Cl. 200/517; 200/341

(57) ABSTRACT

A switch mechanism has improved switch button durability and operational feeling. Constitution and assembly are simplified. A switch mechanism includes a wiring board having first and second electrodes; a switch button; a conductor arranged at a position that corresponds to the first and second electrodes; and a supporting plate, arranged such that the conductor is disposed between the wiring board and the supporting plate and provided with a protruding section at a position that corresponds to the switch button. When the switch button is not depressed, the conductor contacts only the second electrode without contacting the first electrode. When the switch button is depressed, the conductor contacts the first electrode by being supported by the protruding section, the first electrode and the second electrode are electrically connected by the conductor, and the protruding section is displaced in a direction the switch button is depressed, with depressing of the switch button.

### TECHNICAL FIELD

### Reference to Related Application

This application is based upon and claims the benefit of the priority of Japanese patent application No. 2008-056536 filed on Mar. 6, 2008, the disclosure of which is incorporated herein in its entirety by reference thereto.

The present invention relates to a switch mechanism and electronic device comprising the switch mechanism, and particularly to a push button switch mechanism and electronic device comprising the switch mechanism.

### BACKGROUND

Regarding electronic devices represented by mobile terminals, there is a current trend of developing devices specializing in added values such as being thin and small from the standpoint of portability. As a result, there have been efforts in reducing the thickness of switch structures with which users operate the devices (for instance Patent Documents 1 and 2).

A key switch structure described in Patent Document 1 has a film portion to which a plurality of key tops is fixed, a presser is located on a surface opposite to the surface to which the key tops of the film portion are fixed, and pressing the key tops presses a switch provided on a substrate via the presser.

A key sheet described in Patent Document 2 comprises a flexible film sheet, a plurality of key tops disposed on the surface of the film sheet, and a plurality of pressers made of a non-thermo-curing type material and formed integrally with the film sheet in positions corresponding to those of the key tops on the backside of the film sheet.

### [Patent Document 1]

Japanese Patent Kokai Publication No. JP-P2007-109486A

### [Patent Document 2]

Japanese Patent Kokai Publication No. JP-P2007-213874A

### SUMMARY

The entire disclosures of Patent Documents 1 and 2 are incorporated herein by reference thereto. The following analysis is given from the standpoint of the present invention.

FIGS. 41 and 42 show schematic cross-sections of a switch mechanism in which a dish-shaped conductor (metal dome) is convex downward (the protrusion faces the direction opposite that of a switch button) and a protruding section depressing the conductor is underneath the conductor (the protrusion of the protruding section faces the direction of the switch button), unlike the background arts described in Patent Documents 1 and 2. FIG. 41 is a schematic cross-section of the switch mechanism when the switch button 410 is not depressed, and FIG. 42 is a schematic cross-section of the switch mechanism when the switch button 410 is depressed. In the switch mechanism 401, the conductor 404 is disposed underneath a wiring board 405 so as to contact a second electrode 407, and underneath the conductor 404, a supporting plate 402 having the protruding section 402a is disposed.

In the switch mechanism 401, when the switch button 410 is depressed, the wiring board 405 moves towards the direction of the protruding section 402a and so does the conductor 404. As a result, the protruding section 402a depresses the center of the dish-shaped conductor 404, deforming the conductor 404 and making its center part protrude out. Electrical continuity between a first electrode 406 and the second electrode 407 can be obtained by having the protruding center part contact the first electrode 406 of the wiring board 405.

However, at this time, not only the wiring board 405, but also the switch button 410 is deformed along the shape of the protruding section 402a. For instance, when the supporting plate 402 (the protruding section 402a) is made of metal and the switch button 410 is made of resin, depressing the switch button 410 deforms the switch button 410 into a mountain shape since the rigidity of the switch button 410 is lower than that of the protruding section 402a. As a result, stress occurs in the center (indicated by a circle) of the switch button 410. By repeating the depression and release of the switch button 410, the deformation of the switch button 410 into the mountain shape and its recovery is also repeated, causing fatigue failure of the center part of the switch button 410. The switch button 410, thinly formed in order to reduce the thickness of the switch mechanism 401, is especially susceptible to fatigue failure.

Even in the key switch structure described in Patent Document 1 and the key sheet described in Patent Document 2 in which the directions of the protrusion and the conductor are flipped vertically, compared to the switch mechanism shown in FIG. 41, the center part of the key top (switch button) may be susceptible to fatigue failure. Further, in the key switch structure described in Patent Document 1 and the key sheet described in Patent Document 2, when an illumination sheet that illuminates the switch button is provided, it is preferable that the illumination sheet be interposed between the key top and the presser (the protruding section), however, since there is a space between the illumination sheet and the printed wiring board in this configuration, the wiring structure for supplying power gets complicated and the assembly operation becomes intricate.

Further, in the switch mechanism shown in FIG. 41, the key switch structure described in Patent Document 1, and the key sheet described in Patent Document 2, if the conductor (metal dome) is made thin so as to make the switch mechanism thinner, the stroke of a switch button depression needed to obtain a predetermined electrical continuity will be shorter, and the operational feeling when the switch button is depressed, i.e., a sensation that lets the operator recognize that the switch button has been depressed, will be dull.

It is an object of the present invention to provide a switch mechanism wherein the durability of a switch button and the operational feeling are improved, and constitution and assembly are simplified.

According to a first aspect of the present invention, there is provided a switch mechanism comprising a wiring board having at least one first electrode and at least one second electrode on one surface, at least one switch button disposed on the other surface of the wiring board and receiving a depressing operation from the outside, at least one conductor disposed at a location(s) corresponding to the first electrode and the second electrode on the surface of the wiring board, and a supporting plate disposed in such a manner that the conductor is interposed between the wiring board and the supporting plate and having at least one protruding section at a location corresponding to the at least one switch button. The conductor contacts only the second electrode and not the first electrode in a state where the switch button is not depressed. In a state where the switch button is depressed, the conductor contacts the first electrode by being supported by the protruding section, the first electrode and the second electrode are electrically connected by the conductor, and the protruding section is displaced in a direction in which the switch button is depressed upon depression of the switch button.

According to a preferred mode of the first aspect, the displacement of the protruding section is restored when the switch button is released.

According to a preferred mode of the first aspect, an operation of depressing the switch button displaces the protruding section by 0.05 mm to 0.15 mm in the direction in which the switch button is depressed.

According to a preferred mode of the first aspect, the supporting plate comprises a thin portion, having a thickness thinner than other region(s), formed so as to be bent by an operation of depressing the switch button in at least one region surrounding the protruding section.

According to a preferred mode of the first aspect, the thin portion is formed adjacent to the protruding section and surrounding the protruding section.

According to a preferred mode of the first aspect, the thin portion is formed surrounding the protruding section without being adjacent to the protruding section.

According to a preferred mode of the first aspect, the thin portion comprises at least one through hole.

According to a preferred mode of the first aspect, the supporting plate is made of stainless steel. The thickness of the thin portion is 0.1 mm to 0.2 mm.

According to a preferred mode of the first aspect, the conductor is dish-shaped and its concave portion faces the wiring board. The conductor contacts the first electrode by having a part of the concave portion of the conductor elevated in a direction of the wiring board due to pressure from the protruding section upon the depression of the switch button.

According to a preferred mode of the first aspect, the switch button is made of resin.

According to a second aspect of the present invention, there is provided an electronic device comprising a switch mechanism. The switch mechanism comprises a wiring board having at least one first electrode and at least one second electrode on one surface, at least one switch button disposed on the other surface of the wiring board and receiving a depressing operation from the outside, at least one conductor disposed at a location(s) corresponding to the first electrode and the second electrode on the surface of the wiring board, and a supporting plate disposed in such a manner that the conductor is interposed between the wiring board and the supporting plate and having at least one protruding section at a location corresponding to the at least one switch button. The conductor contacts only the second electrode and not the first electrode in a state where the switch button is not depressed. In a state where the switch button is depressed, the conductor contacts the first electrode by being supported by the protruding section, the first electrode and the second electrode are electrically connected by the conductor, and the protruding section is displaced in a direction in which the switch button is depressed upon depression of the switch button.

According to a preferred mode of the second aspect, the supporting plate is a part of a case housing internal parts of the electronic device.

According to a preferred mode of the second aspect, the supporting plate comprises a thin portion, having a thickness thinner than other region(s), formed so as to be bent by an operation of depressing the switch button in at least one region surrounding the protruding section.

According to a preferred mode of the second aspect, the thin portion comprises at least one through hole.

The present invention has at least one of the following effects.

According to the present invention, the deformation of the switch button along the protruding section can be mitigated by having an operation of depressing the switch button displace the protruding section in the depressing direction. As a result, the stress occurring on the switch button can be reduced, and fatigue failure of the switch button can be mitigated.

According to the present invention, the range of the resiliency felt by the operator can be enlarged by having an operation of depressing the switch button displace the protruding section in the depressing direction. As a result, the operator can obtain a clear operational feeling even if the movable stroke of the conductor is short.

According to the present invention, the illumination sheet can be interposed between the switch button and the wiring board, thereby simplifying the constitution of the switch mechanism and the electronic device and facilitating the manufacturing thereof.

As a result, according to the present invention, the durability of the switch mechanism can be improved, and a desirable sense of clicking can be maintained.

### BRIEF DESCRIPTION OF THE DRAWINGS

FIG. 1 is a schematic partial cross-section of a switch mechanism relating to a first exemplary embodiment of the present invention.

FIG. 2 is a schematic partial plan of a supporting plate in the switch mechanism relating to the first exemplary embodiment shown in FIG. 1.

FIG. 3 is a schematic partial cross-section showing a state where a switch button is depressed in the switch mechanism relating to the first exemplary embodiment of the present invention.

FIG. 4 is a comparison chart illustrating the relation between the depressed amount and the repulsive force (resiliency) of the switch button.

FIG. 5 is a schematic partial cross-section of a supporting plate relating to another shape and form.

FIG. 6 is a schematic partial cross-section of a supporting plate relating to another shape and form.

FIG. 7 is a schematic partial cross-section of a supporting plate relating to another shape and form.

FIG. 8 is a schematic partial cross-section of a supporting plate relating to another shape and form.

FIG. 9 is a schematic partial cross-section of a supporting plate relating to another shape and form.

FIG. 10 is a schematic partial cross-section of a supporting plate relating to another shape and form.

FIG. 11 is a schematic partial cross-section of a switch mechanism relating to a second exemplary embodiment of the present invention.

FIG. 12 is a schematic partial plan of a supporting plate in the switch mechanism relating to the second exemplary embodiment shown in FIG. 11.

FIG. 13 is a schematic partial cross-section of a supporting plate relating to another shape and form.

FIG. 14 is a schematic partial cross-section of a supporting plate relating to another shape and form.

FIG. 15 is a schematic partial cross-section of a supporting plate relating to another shape and form.

FIG. 16 is a schematic partial cross-section of a supporting plate relating to another shape and form.

FIG. 17 is a schematic plan of a switch mechanism relating to a third exemplary embodiment of the present invention.

FIG. 18 is a schematic cross-section along line XVIII-XVIII in FIG. 17.

FIG. 19 shows a schematic partial cross-section illustrating a state where a switch button is depressed in the switch mechanism relating to the third exemplary embodiment of the present invention.

FIG. 20 is a schematic partial cross-section of a switch mechanism relating to a first aspect of a fourth exemplary embodiment of the present invention.

FIG. 21 is a schematic partial cross-section for explaining an electrical connection between a reinforcing portion and a wiring board.

FIG. 22 is a schematic partial cross-section for explaining an electrical connection between a reinforcing portion and a wiring board.

FIG. 23 is a schematic partial cross-section for explaining an electrical connection between a reinforcing portion and a wiring board.

FIG. 24 is a schematic partial cross-section of a switch mechanism relating to a second aspect of the fourth exemplary embodiment of the present invention.

FIG. 25 is a schematic partial cross-section for explaining an electrical connection between a reinforcing portion and an illumination sheet.

FIG. 26 is a schematic partial cross-section of a switch mechanism relating to a third aspect of the fourth exemplary embodiment of the present invention.

FIG. 27 is a schematic partial cross-section of a switch mechanism relating to a first aspect of a fifth exemplary embodiment of the present invention.

FIGS. 28A, 28B, and 28C are a schematic plan and schematic cross-sections of a reinforcing portion in the switch mechanism relating to the fifth exemplary embodiment of the present invention.

FIG. 29 is a schematic cross-section of the switch mechanism relating to the third exemplary embodiment of the present invention.

FIGS. 30A and 30B are a schematic plan and cross-section showing an example of a reinforcing portion having a deformation assisting portion.

FIGS. 31A and 31B are a schematic plan and cross-section showing an example of a reinforcing portion having a deformation assisting portion.

FIGS. 32A and 32B are a schematic plan and cross-section showing an example of a reinforcing portion having a deformation assisting portion.

FIGS. 33A and 33B are a schematic plan and cross-section showing an example of a reinforcing portion having a deformation assisting portion.

FIGS. 34A and 34B are a schematic plan and cross-section showing an example of a reinforcing portion having a deformation assisting portion.

FIG. 35 is a schematic plan showing an example of a reinforcing portion having a deformation assisting portion.

FIG. 36 is a schematic plan showing an example of a reinforcing portion having a deformation assisting portion.

FIG. 37 is a schematic partial cross-section of a switch mechanism relating to a second aspect of the fifth exemplary embodiment of the present invention.

FIG. 38 is a schematic perspective of an electronic device relating to the exemplary embodiment of the present invention.

FIG. 39 is a schematic partial disassembly perspective of an operation section of the electronic device shown in FIG. 38.

FIG. 40 is a schematic partial cross-section of a part of a switch mechanism along line XXXX-XXXX in FIG. 38.

FIG. 41 is a schematic partial cross-section of a switch mechanism for explaining the problems that the present invention attempts to solve.

FIG. 42 is a schematic partial cross-section showing a state where a switch button is depressed in the switch mechanism shown in FIG. 41.

### PREFERRED MODES

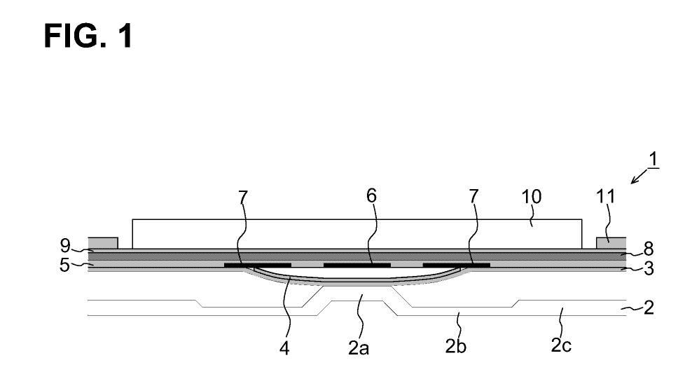

A switch mechanism relating to a first exemplary embodiment of the present invention will be described. FIG. 1 shows a schematic partial cross-section of the switch mechanism relating to the first exemplary embodiment of the present invention. FIG. 1 is a schematic cross-section of one switch button part.

The switch mechanism 1 comprises a supporting plate 2, an adhesive sheet 3, at least one conductor 4, a wiring board 5 having a first electrode 6 and a second electrode 7, an illumination sheet 8, a thin sheet 9, at least one switch button 10, and a cover portion 11.

The switch button 10 is a button with which the operator performs an input operation and is joined onto the thin sheet at a predetermined position. The switch button 10 can be manufactured with resin such as acrylic resin or polycarbonate, and can be formed, for instance, by injection molding in this case. Further, the thickness of the switch button 10 can be, for instance, approximately 0.3 mm. The thin sheet 9 can be manufactured using resin such as polycarbonate, and its thickness can be, for instance, approximately 0.05 mm. The cover portion 11 having a through hole into which the switch button 10 fits is disposed on the thin sheet 9. Note that the cover portion 11 does not have to be provided between adjacent switch buttons 10.

The illumination sheet 8 illuminates the switch button 10 and is disposed underneath the switch button 10 and the thin sheet 9. For instance, an inorganic EL sheet can be used as the illumination sheet 8, and its thickness can be, for instance, approximately 0.1 mm. Further, a light guiding sheet having a light-emitting source such as an LED at its end, guiding light into the illumination sheet 8, and having a desired area illuminated can be used as the illumination sheet 8.

The wiring board 5 is disposed below the switch button 10, and it is preferable that the wiring board 5 be deformable according to the displacement of the switch button 10 when the switch button 10 is depressed. For instance, it is preferable that the wiring board 5 be formed as a flexible printed circuit board (FPC). On the wiring board 5, the first electrode 6 and the second electrodes 7 surrounding the first electrode 6 like a ring are formed for each switch button 10.

The conductor 4 is provided for each switch button 10 and electrically connects the first electrode 6 and the second electrode 7 when the switch button 10 is depressed. In the mode shown in FIG. 1, the conductor 4 is held by the adhesive sheet 3 underneath the first electrode 6 and the second electrode 7 in such a manner that at least a part of the end (or the periphery) of the conductor 4 contacts the second electrode 7. In a state where the switch button 10 is not depressed, the conductor 4 does not contact the first electrode 6. It is preferable that the conductor 4 be a dish-shaped metal plate (disc spring or metal dome), and the concavity faces the wiring board 5. Further, the conductor 4 is disposed so that the center part (preferably the most concave part) of the conductor 4 is right below the first electrode 6, and it is preferable that the centers of the first electrode 6 and the conductor 4 overlap each other. It is preferable that the conductor 4 be flexible or elastic enough that the center part 4a protrudes when the protrusion is depressed and it restores its normal form when the depression is released. In the mode shown in FIG. 1, the conductor 4 is held by the adhesive sheet 3 in such a manner that at least a part of the end (or the periphery) 4b of the conductor 4 electrically contacts the second electrode 7. In a state where the switch button 10 is not depressed, the center part 4a (preferably the most concave part) of the conductor 4 does not contact the first electrode 6. Further, the conductor 4 is disposed so that the center part 4a of the conductor 4 is right below the first electrode 6, and it is preferable that the centers of the first electrode 6 and the conductor 4 overlap each other. Therefore, in a state where the switch button 10 is depressed, the conductor 4 contacts the first electrode 6 by having the center part 4a supported by a protruding section 2a of the supporting plate 2 and electrically connects the first electrode 6 and the second electrode 7. When the depression of the switch button 10 is released, the conductor 4 returns to its original form.

The illumination sheet 8 that illuminates the switch button 10 is laminated between the wiring board 5 and the switch button 10. The thin sheet 9, to which the switch button 10 is joined, is laminated on the illumination sheet 8. At this time, the switch button 10 is disposed so as to be located on the first electrode 6 and the second electrode 7. Further, on the thin sheet 9, the cover portion 11 having the through hole into which the switch button 10 fits is disposed.

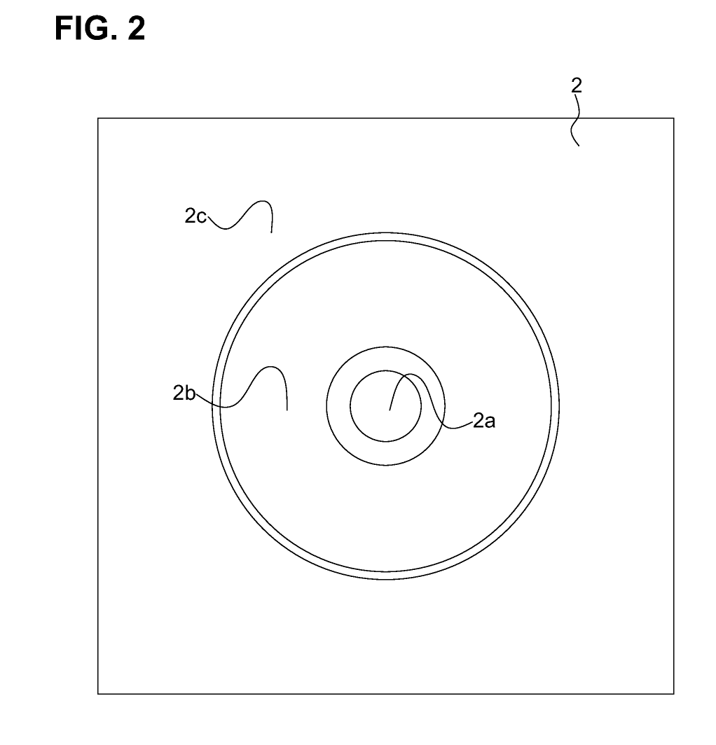

Underneath the adhesive sheet 3, the supporting plate 2 is disposed. FIG. 2 shows a schematic partial plan of the supporting plate in the switch mechanism relating to the first exemplary embodiment shown in FIG. 1. FIG. 2 is a schematic plan of one protruding section 2a and a thin portion 2b. The supporting plate 2 has the protruding section 2a underneath the first electrode 6. The protruding section 2a preferably has a flat upper part, and is, for instance, cone-shaped. It is preferable that the upper surface of the protruding section 2a be flat or gently curved and that the protruding section 2a is disposed so as to be located underneath the first electrode 6. It is even more preferable that the center of the upper surface of the protruding section 2a, the center of the first electrode, and the most concave part of the conductor 4 (the center part of the conductor 4) be aligned. Further, it is preferable that the upper surface of the protruding section 2a contact the adhesive sheet 3 when the switch button 10 is not depressed.

The positional relations between the switch button 10, the first electrode 6, the conductor 4, and the protruding section 2a of the supporting plate 2 should be such that the protruding section 2a presses and elevates the center part 4a of the conductor 4 when the switch button 10 is depressed thereby electrically connecting the elevated center part 4a of the conductor 4 and the first electrode 6.

Around the periphery of the protruding section 2a, the supporting plate 2 further has the thin portion 2b formed thinner than other part (a thick portion 2c). The thin portion 2b is formed so as to be bent (be deformed) by the elasticity of the conductor 4 or the pressure force from the switch button 10 when the switch button 10 is depressed, lowering the protruding section 2a. For instance, the thin portion 2b can be formed so that the protruding section 2a is displaced by a length between 0.05 mm and 0.15 mm when the switch button 10 is depressed with a force between 5 N and 50 N. Further, the thin portion 2b is formed so that the protruding section 2a returns to its original form when the switch button 10 is not depressed.

In the supporting plate 2 shown in FIGS. 1 and 2, the protruding section 2a, the thin portion 2b, and the thick portion 2c are formed connectedly. In the present mode, the thin portion 2b is created by forming a concave portion on the surface of the supporting plate 2 that faces the wiring board 5 and the others. The supporting plate 2 shown in FIGS. 1 and 2 can be molded by, for instance, pressing.

In FIG. 2, the planar shape of the protruding section 2a and the thin portion 2b is circular, however, it is not limited to this and various shapes such as oval and polygon may be selected. Further, the planar shapes of the protruding section 2a and the thin portion 2b do not have to be the same.

It is preferable that the supporting plate 2 be created with a material elastic enough that it bends when the switch button 10 is depressed and returns to its original form when the depression is released. For instance, the supporting plate 2 can be created with a sheet metal such as stainless steel (SUS). For instance, when the supporting plate 2 is created with a sheet metal of stainless steel (SUS) having a thickness of approximately 0.3 mm, it is preferable that the thin portion 2b be molded with a thickness of, for instance, 0.1 mm to 0.2 mm, compared to the original thickness (the thickness of the thick portion 2c) of the sheet metal: approximately 0.3 mm. Further, it is preferable that the region determined by the outer circumference of the thin portion 2b be larger than the outer shape of the conductor 4. When the protruding section 2a and the thin portion 2b are formed by pressing, while excess portions created by thinning the sheet metal and creating the thin portion 2b at the time of pressing is moved towards a region where the protruding section 2a is molded, the protruding section 2a can be drawn into cylindrical or circular truncated cone shape. The height of the protruding section 2a is suitably determined according to the depression stroke length of the switch button 10. For instance, the height of the protruding section 2a can be set so that the stroke length of the switch button 10 is more or less 0.2 mm after adding a margin to the movable stroke of the conductor 4 (the depth of the dish). In this case, the height of the protruding section 2a can be, for instance, 0.05 mm to 0.25 mm from the surface of the thin portion 2b. Unnecessary excess portions at the time of pressing is removed. When the planar shape of the upper surface of the protruding section 2a is circular as shown in FIG. 2, its diameter can be set to, for instance, φ 1.0 mm to 2.0 mm

It is preferable that the supporting plate 2 be integrally formed as a part of a case that houses the switch mechanism 1 of the present invention and other parts. In other words, it is preferable that a surface (the bottom surface) of the case be used as the supporting plate and that the protruding section 2a and the thin portion 2b be formed on this surface.

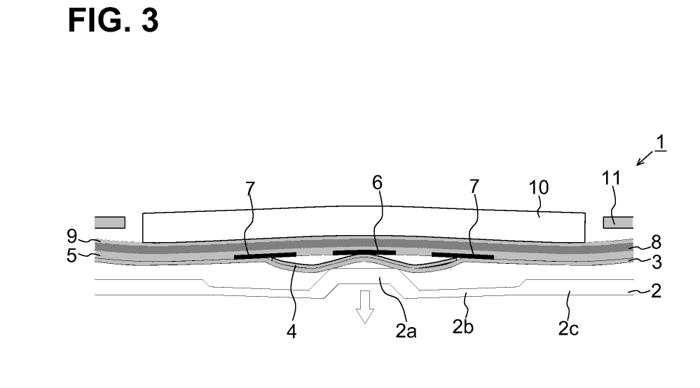

FIG. 3 shows a schematic cross-section showing the state where the switch button is depressed in the switch mechanism relating to the first exemplary embodiment of the present invention. When the switch button 10 is depressed by the operator, the wiring board 5 and the illumination sheet 8 are pressed towards the direction of the supporting plate 2. At the same time, the periphery of the conductor 4 contacting the second electrode 7 is displaced downward. At this time, since the center part of the conductor 4 is supported by the protruding section 2a, the center part of the conductor 4 is pressed by the protruding section 2a due to the displacement of the periphery of the conductor 4 and the conductor 4 is deformed having the concave center part elevated. As a result, by having the center part of the conductor 4 contact the first electrode 6, electrical continuity between the first electrode 6 and the second electrode 7 is obtained. The protruding section 2a has the functions of deforming the center part of the conductor 4 when the switch button 10 is depressed and of making it easier, with its resiliency, for the operator of the switch button 10 to recognize the operational feeling that the switch button 10 has been depressed. When the depression of the switch button 10 is released, the wiring board 5, the illumination sheet 8, and the other parts move upward (return to their original positions). As a result, the pressure from the protruding section 2a of the supporting plate 2 to the center part 4a of the conductor 4 is released as well, and the conductor 4 returns to its original form. Once the conductor 4 has returned to its original form, the electrical continuity between the first electrode 6 and the center part 4a is cut off.

When the switch button 10 is depressed, the thin portion 2b of the supporting plate 2 is bent, displacing the protruding section 2a downward. This displacement has a function of giving the operator a clear feeling that the switch button 10 is operated between when the switch button 10 is just depressed and when the conductor 4 contacts the first electrode 6, and a function of mitigating fatigue failure of the switch button 10 after the conductor 4 has contacted the first electrode 6. Effects of the bending of the thin portion 2b, before and after the conductor 4 contacts the first electrode 6, will be described respectively.

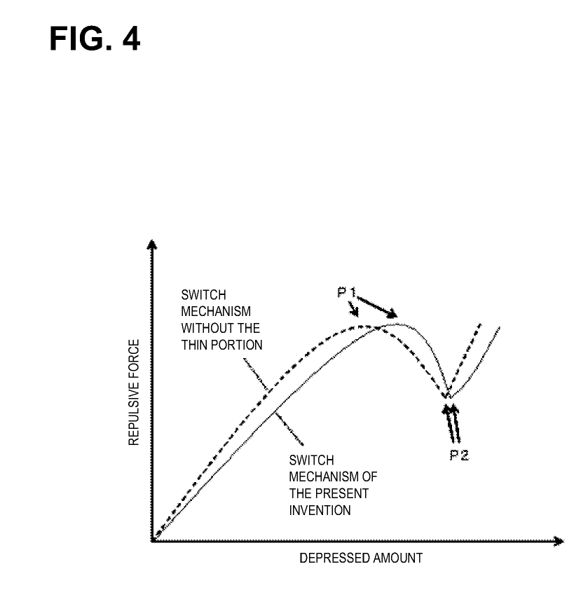

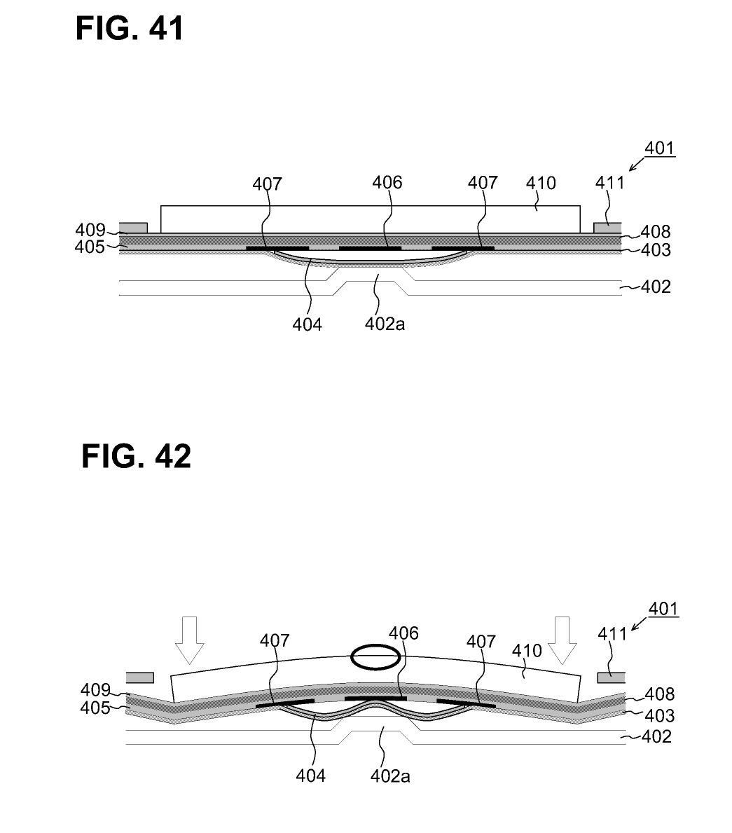

First, the function of the thin portion 2b from when the switch button 10 is depressed to when the conductor 4 contacts the first electrode 6 will be described. FIG. 4 shows a graph illustrating the relation between the depressed amount and the repulsive force, i.e., resiliency (the operational feeling felt by the operator) of the switch button. In FIG. 4, the switch mechanism 1 of the present invention is compared to the switch mechanism 401 having no thin portion, shown in FIG. 41. As the operator gradually presses the switch buttons 10 and 410 in the switch mechanisms 1 and 401, the center parts of the dish-shaped conductors 4 and 404 are pressed by the protruding sections 2a and 402a and start to be deformed, elevating. As the conductors 4 and 404 are deformed, the resiliency increases, however, the thin portion 2b is bent due to this resiliency in the switch mechanism 1 of the present invention. The resiliency of the conductors 4 and 404 eventually reaches its maximum value (Point P1). After this point, the resiliency of the conductors 4 and 404 decreases as the operator continues to press the buttons. At the same time, the bent thin portion 2b starts to restore its original form. As the operator further continues to press the switch buttons 10 and 410, the center parts of the conductors 4 and 404 contact the first electrodes 6 and 406 and electrical continuity between the first electrodes 6 and 406 and the second electrodes 7 and 407 is obtained, thanks to the conductors 4 and 404 (Point P2). After this point, since the conductors 4 and 404 can be no longer deformed, the resiliency starts to increase again due to the rigidity of the supporting plates 2 and 402.

The operator recognizes the feeling that he is operating the switch buttons 10 and 410 because of the change in resiliency from Point P1 to Point P2. In the switch mechanism 1 of the present invention, as the resiliency of the conductor 4 increases, the thin portion 2b is bent between the start of the depression and the maximum resiliency point (Point P1) and the protruding section 2a moves towards the direction of the depression. Then, after the maximum resiliency point (Point P1), as the resiliency of the conductor 4 decreases, the thin portion 2b recovers from the bent state and the protruding section 2a tries to return to its original position. Therefore, compared to the switch mechanism 401 without any thin portion, shown in FIG. 41, the change in resiliency against the change in the depressed amount is larger between Point P1 and Point P2 in the switch mechanism 1 of the present invention (the line in the graph in FIG. 4 has a more steep slope). Due to the change in resiliency, the operator of the switch mechanism 1 of the present invention can have a clearer operational feeling even when the movable stroke of the conductor 4 is short, compared to when he operates the switch mechanism 401 shown in FIG. 41.

Next, the function of the thin portion 2b after the conductor 4 has contacted the first electrode 6 will be described. When the center part of the conductor 4 comes into contact with the first electrode 6, the pressure of the switch button 10 is added to the protruding section 2a. Because of this pressure, the thin portion 2b is bent and the protruding section 2a moves downward as much as the thin portion 2b is bent. In other words, the height of the protruding section 2a on the surface of the supporting plate 2 decreases. As a result, the stress occurring on the center part of the switch button 10 is reduced since the deformation of the switch button 10 along the protruding section 2a is mitigated, and the switch button 10 can be used longer. On the other hand, in the switch mechanism 401 without any thin portion shown in FIG. 41, since the protruding section 402a does not move downward, the mountain-shaped angle of the switch button 410 along the protruding section 402a is sharper than in the switch mechanism of the present invention. In other words, the stress occurring on the center part of the switch button 410 is larger. As a result, with repeated pressing of the switch button 410, the switch button 410 in the switch mechanism 401 shown in FIG. 41 is more susceptible to fatigue failure, compared to the switch button 10 in the switch mechanism 1 of the present invention.

According to the switch mechanism of the present invention, by having the protruding section move when the switch button is depressed, a clear operational feeling can be given to the operator and the switch button can have a longer life. Further, the illumination sheet can be interposed between the switch button and the wiring board, thereby simplifying constitution and assembly.

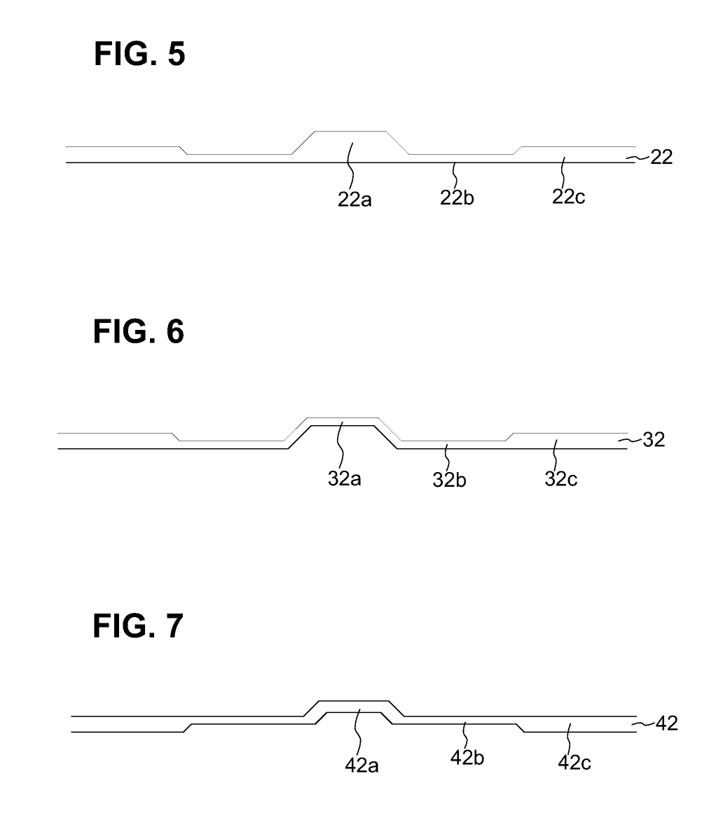

The shape and form of the supporting plate are not limited to the ones shown in FIGS. 1 and 2, and any shape and form can be employed as long as it can be deformed when the switch button 10 is depressed. For instance, supporting plates shown in FIGS. 5 to 10 can be used. FIGS. 5 to 10 show schematic cross-sections of the supporting plates.

The supporting plate 22 shown in FIG. 5 has the same shape as the supporting plate 2 shown in FIGS. 1 and 2, however, the body of a protruding section 22a is solid (the concave portion corresponding to the protruding section 22a is not formed on the back of the supporting plate 22). The supporting plate 22 as described can be manufactured by molding the protruding section 22a and a thin portion 22b using a forging process.

In the supporting plate 32 shown in FIG. 6, the thicknesses of a protruding section 32a and a thin portion 32b are the same. The supporting plate 32 as described can be manufactured by first molding the regions of the thin portion 32b and the protruding section 32a by etching, and then molding the protruding section 32a using a drawing process.

In the supporting plate 42 shown in FIG. 7, a thin portion 42b is created by thinning a surface (i.e., a surface not facing the wiring board and the other parts) opposite to the one from which a protruding section 42a protrudes.

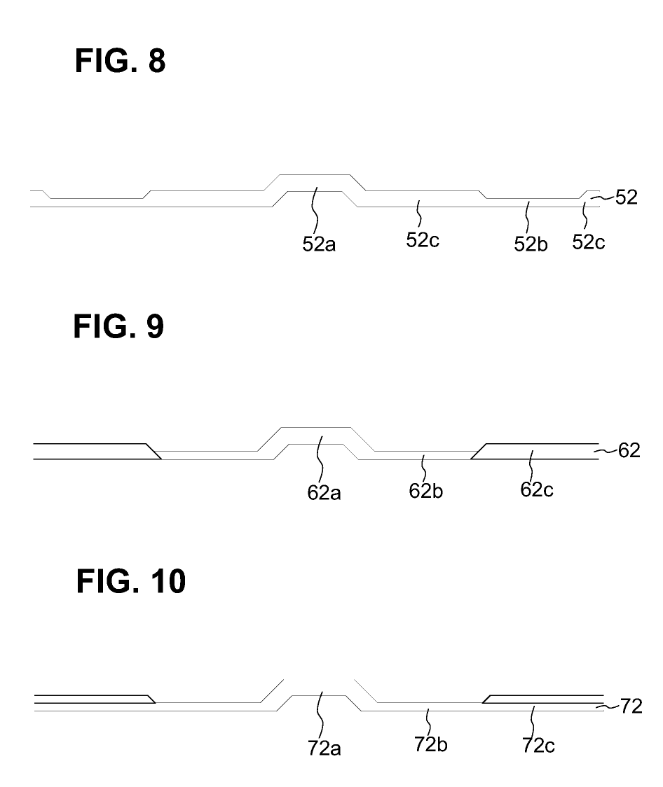

In the supporting plate 52 shown in FIG. 8, a protruding section 52a and a thin portion 52b are not formed adjacently. A predetermined area of a thick portion 52c is interposed between the thin portion 52b and the edge of the protruding section 52a. In this case, the protruding section 52a and the thick portion 52c are formed adjacently, and the thin portion 52b is formed between the protruding section 52a and the thick portion 52c.

In the supporting plate 62 shown in FIG. 9, a protruding section 62a and a thin portion 62b are molded using different members, and the molded protruding section 62a and thin portion 62b are joined to a through hole on the main body of the supporting plate 62 by caulking.

In the supporting plate 72 shown in FIG. 10, a thick portion 72a is formed using a plurality of layers of members. In other words, a thick region is formed on the original supporting plate by laminating and joining a plurality of members by spot welding, and a region where these members are not laminated becomes a thin portion 72b.

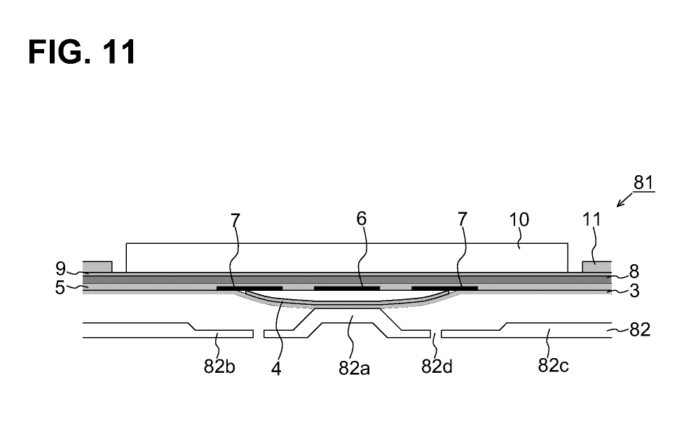

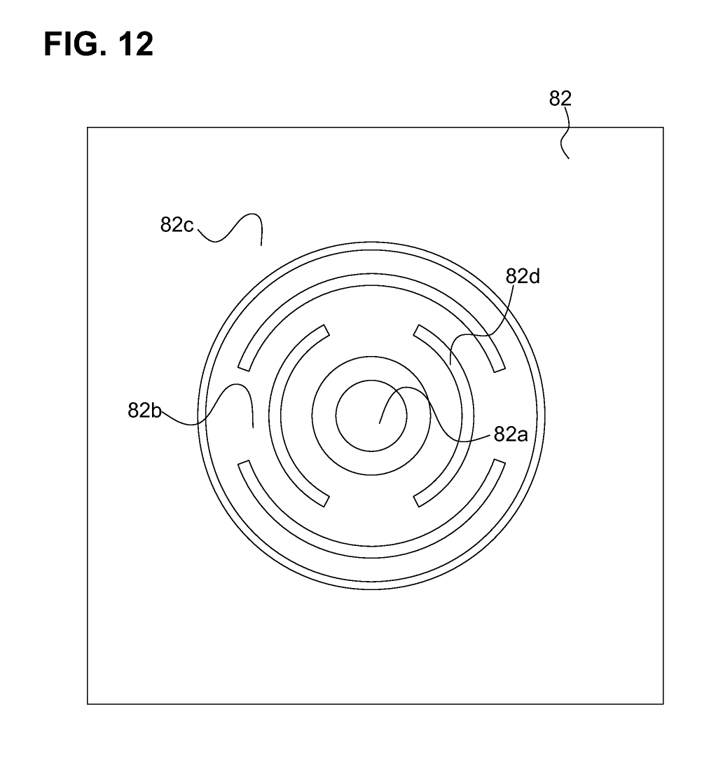

Next, a switch mechanism relating to a second exemplary embodiment of the present invention will be described. FIG. 11 shows a schematic partial cross-section of the switch mechanism relating to the second exemplary embodiment of the present invention. FIG. 12 shows a schematic partial plan of a supporting plate in the switch mechanism relating to the second exemplary embodiment shown in FIG. 11. In the supporting plate 82 in the present mode, through holes 82d are formed on the thin portion of the supporting plate in the first exemplary embodiment. Except for the supporting plate, the shape and form of the switch mechanism 81 is identical to the switch mechanism relating to the first exemplary embodiment. Further, in FIGS. 11 and 12, the same symbols are given to the elements same as those in the first exemplary embodiment.

In the mode shown in FIG. 12, a plurality of arcuate through holes 82d are formed concentrically with the center of the thin portion 82b (a protruding section 82a) on the supporting plate 82. According to the present mode, by forming the through holes 82d on the thin portion 82b, the thin portion 82b is more easily bent when the switch button 10 is depressed, compared to the first exemplary embodiment. As a result, the operational feeling of the switch button 10 becomes clearer, and the stress occurring on the switch button 10 can be reduced further.

The shape, size, number, and arrangement of the through holes can be suitably set, depending on how much one wants the thin portion to be bent and how much one wants the protruding section to move downward. FIGS. 13 and 14 show schematic partial plans of supporting plates illustrating examples of the through holes.

In the supporting plate shown in FIG. 13, a plurality of circular through holes 92d are arranged around a protruding section 92a at an equal interval and formed like a chain-lined circle concentric with the center of the protruding section 92a. The shape of each through hole 92d is not limited to circle, and various shapes such as oval and polygon can be selected. Further, the size of each through hole 92d does not have to be the same. The through holes 92d do not have to be arranged at an equal interval, either.

In the supporting plate shown in FIG. 14, a spiral-shaped through hole 102d is formed as if to coil around a protruding section 102a. The number of the spiral-shaped through hole is not limited to one, and a plurality of them may be formed.

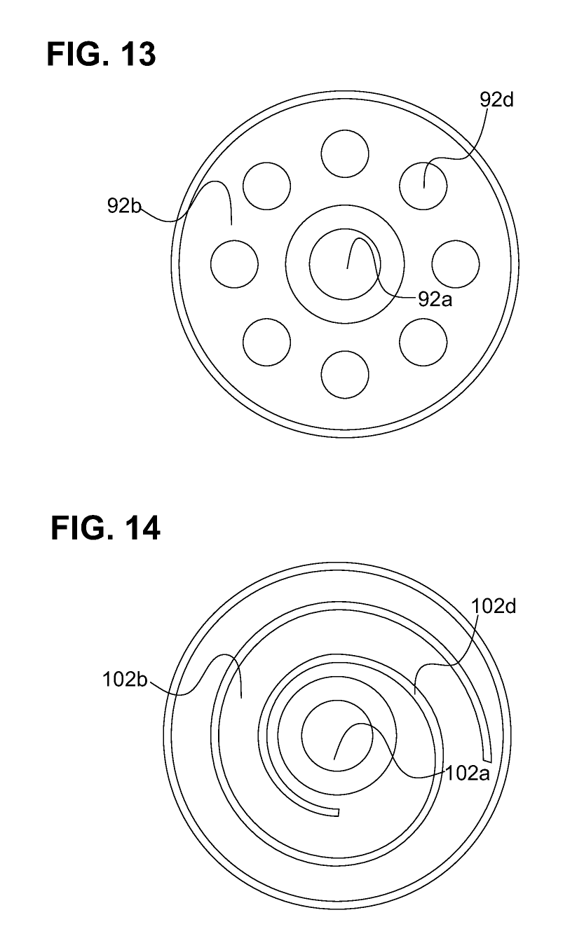

In the supporting plate shown in FIG. 15, a plurality of linear-shaped through holes 112d are formed around a protruding section 112a, and the plurality of the through holes 112d as a whole form a rectangle surrounding the protruding section 112a. The shape of each through hole 112d and the shape formed by the plurality of the through holes 112d as a whole are not limited to the shapes shown in FIG. 15, and various shapes may be selected. For instance, each through hole may take the shape of a curve or wave. Further, the shape formed by the plurality of the through holes may be a polygon, circle, or oval, in addition to a square.

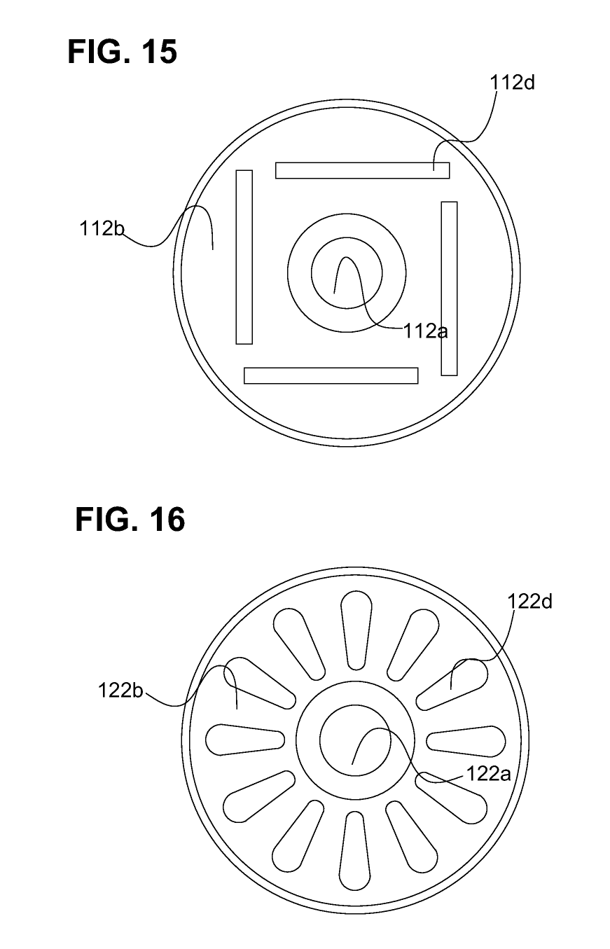

In the supporting plate shown in FIG. 16, a plurality of petaloid through holes 122d are formed radially at an equal interval with a protruding section 122a as the center. The shape of each through hole is not limited to petal-shape, and various shapes such as oval or rectangle can be selected. Further, each through hole does not have to be arranged at an equal interval.

The method for forming the through holes may be a chemical process such as etching or a physical method such as a machining process.

The present mode has been described using the supporting plate shown in FIGS. 1 and 2 as the basis, however, for instance, the present mode can be applied to the other variations of the supporting plates shown in FIGS. 5 to 10 without being limited to the above examples.

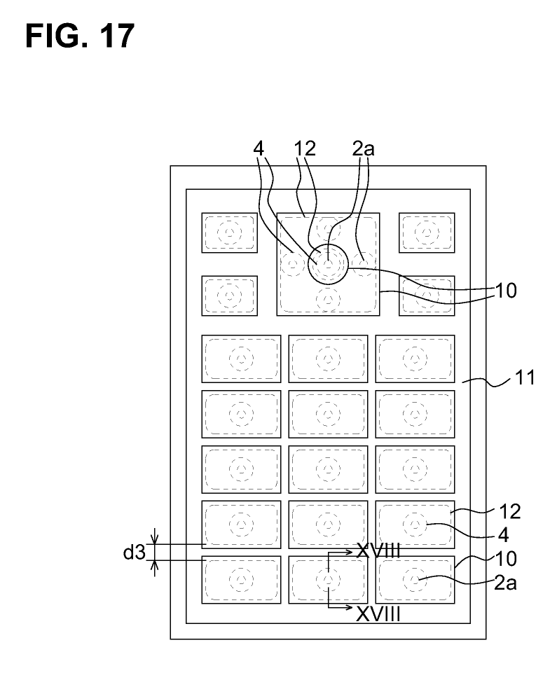

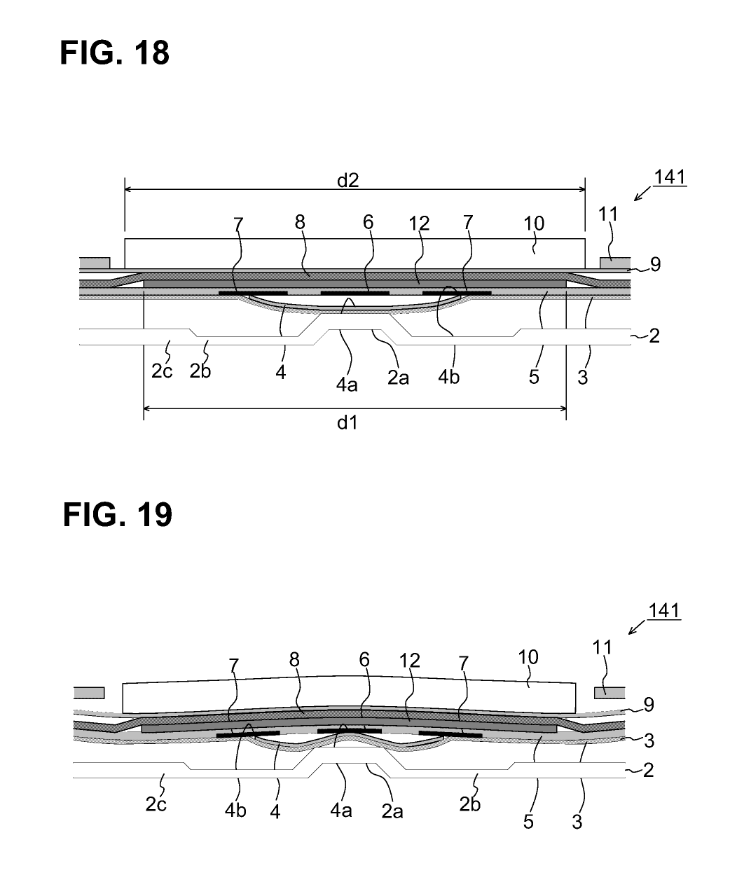

Next, a switch mechanism relating to a third exemplary embodiment of the present invention will be described. FIG. 17 shows a schematic plan of the switch mechanism relating to the third exemplary embodiment of the present invention. FIG. 17 is a schematic partial plan of a mobile telephone device as an example of an electronic device of the present invention and shows an example in which the switch mechanism of the present invention is applied to an operation section of the mobile telephone device. Further, in FIG. 17, see-through parts are indicated by broken lines. FIG. 18 is a schematic cross-section along line XVIII-XVIII in FIG. 17 and shows a schematic cross-section of a switch mechanism. Note that, in FIGS. 17 and 18, the same symbols are given to the elements same as those in the first exemplary embodiment.

The third exemplary embodiment differs from the first exemplary embodiment in that the switch mechanism 141 further comprises a reinforcing portion 12. The reinforcing portion 12 is provided for each switch button 10 in order to inhibit the switch button 10 from being excessively curved and deformed due to the shape of the protruding section 2a of the supporting plate 2 when the switch button 10 is depressed and is joined underneath the illumination sheet 8 via an adhesion layer (not shown in the drawing). Except for the reinforcing portion 12, the switch mechanism relating to the third exemplary embodiment is identical to the switch mechanism relating to the first exemplary embodiment.

It is preferable that the size (area) and rigidity of the reinforcing portion 12 be set so as to inhibit the switch button 10 from being curved and deformed when the switch button 10 is depressed. It is also preferable that the rigidity of the reinforcing portion 12 be higher than that of the switch button 10. For instance, when the switch button 10 is an acrylic resin having a thickness of 0.3 mm, a stainless sheet metal having a thickness of 0.1 mm can be used as the reinforcing portion 12. At this time, it is preferable that the corners and edges of the reinforcing portion 12 be beveled so as not to damage the wiring board 5 and the illumination sheet 8. For instance, corners and edges can be rounded by chemical processing. Further, in the planar projection of the button pressing operation surface of the switch button 10 as shown in FIG. 17, it is preferable that the reinforcing portion 12 should not protrude from the switch button 10, that the size (area) of the reinforcing portion 12 should not be larger than that of the switch button 10, and that the reinforcing portion 12 be covered by the switch button 10 (i.e., the switch button 10 overlap the reinforcing portion 12 completely). For instance, in the planar projection of the button pressing operation surface of the switch button 10, it is preferable that the outer edge of the reinforcing portion 12 be inside the outer edge of the switch button 10. In other words, in the cross-section shown in FIG. 18, a cross-sectional dimension d1 of the reinforcing portion 12 should not be larger than a cross-sectional dimension d2 of the switch button 10.

When the rigidities of the reinforcing portion 12 and the switch button 10 are compared, it is preferable to compare them, for instance, using Young's modulus.

Further, it is preferable that the size (area) and the rigidity of the reinforcing portion 12 be set so that the operator is able to obtain a good sense of pressing the button. In the planar projection of the button pressing operation surface of the switch button 10 as shown in FIG. 17, in a case where the area of the reinforcing portion 12 is too small compared to the switch button 10, when the operator locally depresses a region where the reinforcing portion 12 and the switch button 10 do not overlap with, for instance, a nail, the switch button 10 is locally bent, the pressure does not reach the conductor 4, and the operator is not able to obtain a good sense of pressing the button. Therefore, it is preferable that the reinforcing portion 12 be large enough that the switch button 10 does not get deformed locally even when an end of the switch button 10 is locally pressed.

It is preferable that the interval between two adjacent reinforcing portions 12 be equal to or greater than 1.0 mm. For instance, when an interval d3 in FIG. 17 is smaller than 1.0 mm, the bending of the illumination sheet 8 and the wiring board 5 between adjacent switch buttons 10 is inhibited and the operator loses the sense of clicking. For instance, in the planar projection of the button pressing operation surface of the switch button 10 as shown in FIG. 17, when the planar outer shape of the switch button 10 is 10 mm by 6 mm and the interval between two adjacent switch buttons 10 is 0.5 mm, it is preferable that the planar outer shape of the reinforcing portion 12 be equal to or smaller than 9.5 mm by 5.5 mm and that the reinforcing portions 12 be arranged in such a manner that the intervals between the outer edges of the switch buttons 10 and the reinforcing portions 12 are equal to each other.

The reinforcing portion 12 can be of any shape as long as it can inhibit the switch button 10 from being excessively curved and deformed, and for instance, a plate-like material can be used. Further, a material having at least one through hole such as a mesh-like material or frame-like material may be used. Further, the planar outer shape of the reinforcing portion 12 is not limited to square, and various shapes such as circle, oval, and polygon can be employed according to the shape of the switch button 10.

Underneath the illumination sheet 8 and the reinforcing portion 12, the wiring board 5 is disposed. It is preferable that the wiring board 5 be capable of being partially deformed corresponding to the displacement of the switch button 10 when the switch button 10 is depressed and that it be formed as, for instance, a flexible printed circuit board (FPC). On the wiring board 5, the first electrode 6 and the second electrodes 7 surrounding the first electrode 6 like a ring are formed for each switch button 10. A pair of the first electrode 6 and the second electrode 7 is disposed so as to be located underneath the switch button 10 and the reinforcing portion 12.

In the present mode, the reinforcing portion 12 is provided between the illumination sheet 8 and the wiring board 5, however, when the reinforcing portion 12 has at least one through hole, the reinforcing portion 12 may be provided between the switch button 10 and the illumination sheet 8 since the switch button 10 can be illuminated via the through hole.

The wiring board 5 and the illumination sheet 8 are pressed together so as to fill a gap between adjacent reinforcing portions 12. In FIG. 18, the illumination sheet 8 is deformed to accommodate the reinforcing portion 12. Further, an electrode (not shown in the drawing) of the illumination sheet 8 and a terminal (not shown in the drawing) of the wiring board 5 are electrically connected via, for instance, anisotropic conductive paste (ACP) (not shown in the drawing). Further, in a case where the illumination sheet 8 is formed with an inorganic EL sheet, although the inorganic EL sheet has a property of having acoustic noise unique to AC driving, according to the present invention, the acoustic noise can be reduced by attaching the reinforcing portion 12 to the inorganic EL sheet and increasing the weight of the inorganic EL sheet.

FIG. 19 shows a schematic cross-section illustrating a state where the switch button is depressed in the switch mechanism relating to the third exemplary embodiment of the present invention. In the present mode, the reinforcing portion 12 inhibits the switch button 10 from being excessively curved and deformed due to the shape of the protruding section 2a when the switch button 10 is depressed. In other words, the deformation amount of the switch button 10 decreases, compared to the switch mechanism without any reinforcing portion shown in FIG. 1. As a result, the stress on the switch button 10 upon the depression of the switch button 10 can be reduced, and the fatigue failure of the switch button 10 caused by repeated pressing of the switch button 10 can be mitigated. Therefore, according to the switch mechanism 141 of the present invention, the life of the switch mechanism 141 can be prolonged and the endurance reliability can be improved.

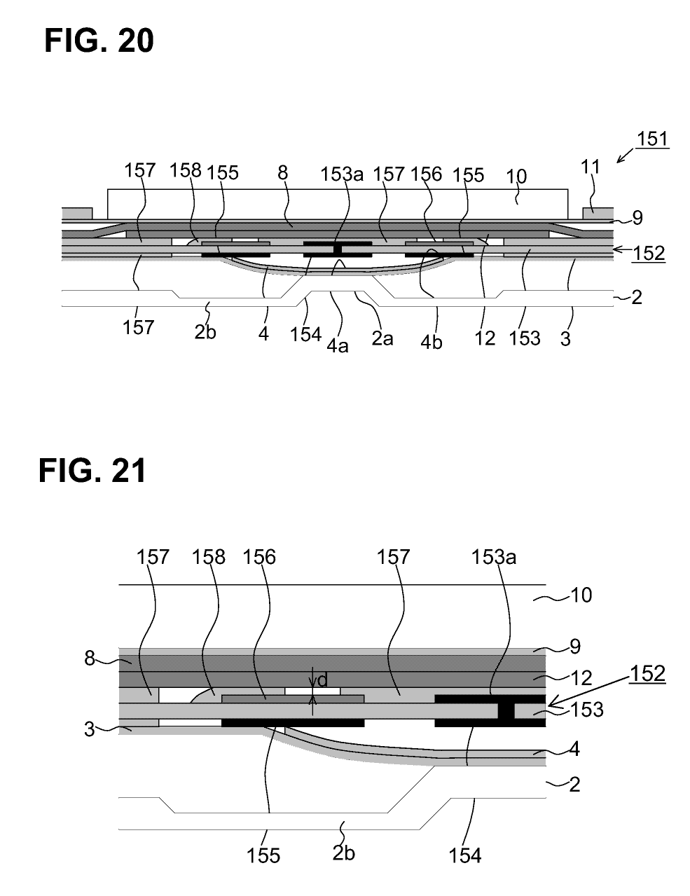

Next, a switch mechanism relating to a fourth exemplary embodiment of the present invention will be described. FIG. 20 shows a schematic partial cross-section of the switch mechanism relating to a first aspect of the fourth exemplary embodiment of the present invention. Note that, in FIG. 20, the same symbols are given to the elements same as those in the first and the third exemplary embodiments.

In the switch mechanism 151 relating to the present mode, the reinforcing portion 12 is electrically connected to a ground potential wiring of a wiring board 152. As a result, by electrically connecting the reinforcing portion 12 in an electrically floating state to the ground, the occurrence of ESD (Electrostatic Discharge) can be prevented and the reliability of the device can be improved. Except for the reinforcing portion 12 and the wiring board 152 of the switch mechanism 151, and the electrical connection between the wiring board 152 and the reinforcing portion 12, the switch mechanism relating to the first aspect of the fourth exemplary embodiment is identical the switch mechanisms relating to the first and the third exemplary embodiments. Further, the second exemplary embodiment may be combined therewith.

FIG. 21 shows a schematic partial cross-section for explaining the electrical connection between the reinforcing portion 12 and the wiring board 152. The wiring board 152 comprises an insulating sheet such as polyimide, a wiring (not shown in the drawing) formed on the insulating sheet, a substrate 153 having electrodes such as a first electrode 154, a second electrode 155, and a ground electrode 156, and an insulating layer 157 covering at least a part of the substrate 153. As in the first exemplary embodiment, the first electrode 154 and the second electrode 155 are the electrodes electrically connected to the conductor 4 when the switch button 10 is depressed. The first electrode 154 is electrically connected to a wiring formed on the opposite surface via a through hole 153a formed on the insulating sheet.

The insulating layer 157 covers wirings that need insulation, and it can be formed with, for instance, epoxy resin or polyimide resin.

The ground electrode 156 is electrically connected to the ground potential wiring (not shown in the drawing). In the present mode, the reinforcing portion 12 is formed with a conductive material, and the ground electrode 156 and the reinforcing portion 12 are electrically connected. It is preferable that the ground electrode 156 be formed on a surface facing the reinforcing portion 12 so as to face the reinforcing portion 12. The ground electrode 156 should be formed at a location where it can be electrically connected to the reinforcing portion 12. For instance, in the mode shown in FIGS. 20 and 21, the ground electrode 156 is formed on the opposite side of the second electrode 155.

The method for electrically connecting the ground electrode 156 and the reinforcing portion 12 is not limited to a particular one, and various methods can be suitably applied. For instance, the ground electrode 156 and the reinforcing portion 12 may be directly contacted each other, or as shown in FIGS. 20 and 21, they may be electrically connected via an electrically conductive adhesive 158. When the wiring (not shown in the drawing) is covered with the insulating layer 157, the height of the insulating layer 157 from the insulating sheet is higher than that of the ground electrode 156. In this case, it is preferable that the electrically conductive adhesive 158 be used since a gap d (of, for instance, 0.01 mm to 0.02 mm) occurs between the ground electrode 156 and the reinforcing portion 12.

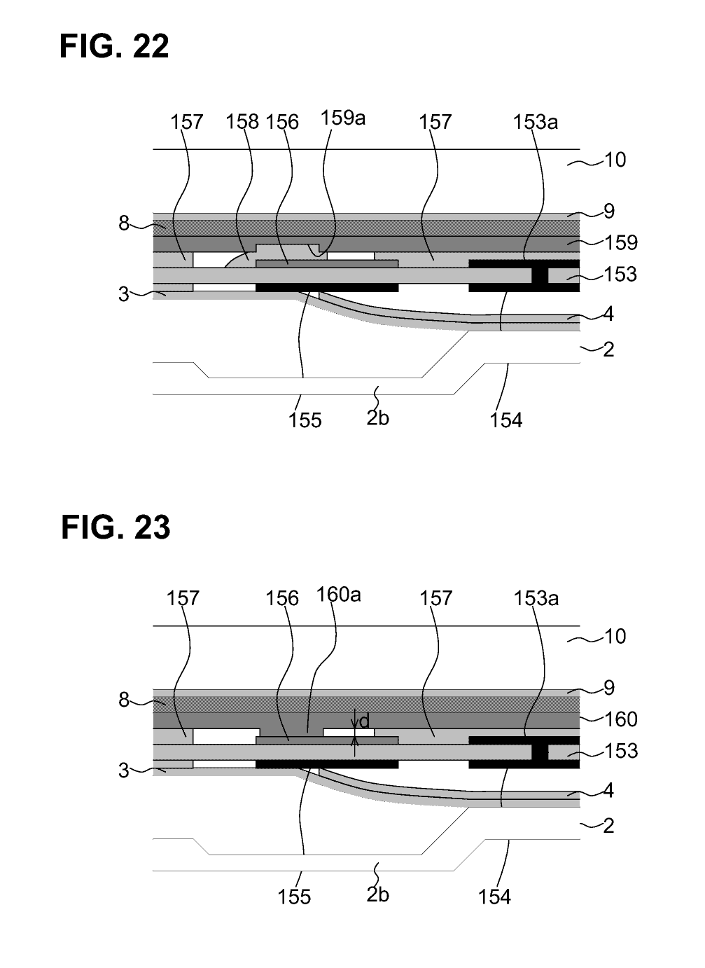

FIG. 22 shows a schematic partial cross-section of a mode different from the mode shown in FIG. 21. In the mode shown in FIG. 22, a reinforcing portion 159 has a concave portion 159a on at least a part of a surface facing the ground electrode 156. The concave portion 159a functions as an adhesive reservoir. For instance, when it is difficult to control the amount of the electrically conductive adhesive 158 applied, the concave portion 159a can prevent the electrically conductive adhesive 158 from being pushed out to unnecessary areas.

FIG. 23 shows a schematic partial cross-section of a mode different from the modes shown in FIGS. 21 and 22. In the modes shown in FIGS. 21 and 22, the electrically conductive adhesive 158 is used to fill the gaps between the ground electrode 156 and the reinforcing portions 12 and 159, however, in the mode shown in FIG. 23, no electrically conductive adhesive is used. In the mode shown in FIG. 23, a reinforcing portion 160 has a protrusion 160a on at least a part of a surface facing the ground electrode 156. The reinforcing portion 160 contacts the ground electrode 156 at the protrusion 160a, obtaining electrical continuity. It is preferable that the height of the protrusion 160a be equal to a gap d between the ground electrode 156 and the reinforcing portion 160, and the height of the protrusion 160a may be adjusted to the gap d by pressing the reinforcing portion 160 against the ground electrode 156. The protrusion 160a can be molded by etching or pressing process.

According to the first aspect of the fourth exemplary embodiment, the occurrence of ESD can be prevented and the reliability of an electronic device using the switch mechanism of the present invention can be improved. Particularly, it is preferable that the present mode be applied to a case where, if a metallic reinforcing portion is in an electrically floating state (a state where it is independent and is not electrically connected to anything), electric charge may accumulate on the reinforcing portion and malfunction and failure of the electronic device caused by ESD may occur.

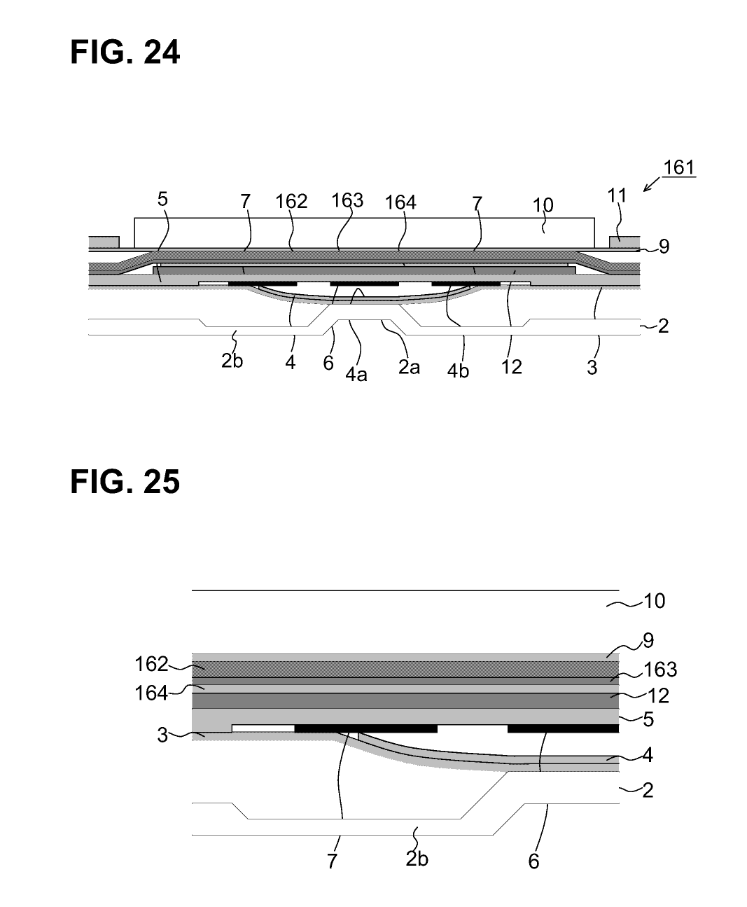

Next, a switch mechanism relating to a second aspect of the fourth exemplary embodiment of the present invention will be described. FIG. 24 shows a schematic partial cross-section of the switch mechanism relating to the second aspect of the fourth exemplary embodiment of the present invention. Note that, in FIG. 24, the same symbols are given to elements same as those in the first aspect.

In the switch mechanism 161 relating to the second aspect of the fourth exemplary embodiment, the reinforcing portion 12 is electrically connected to a ground potential wiring 163 of an illumination sheet 162. As a result, by electrically connecting the reinforcing portion 12 in an electrically floating state to the ground, the occurrence of ESD can be prevented and the reliability of the electronic device can be improved. Except for the reinforcing portion 12 and the illumination sheet 162 of the switch mechanism 161, and the electrical connection between the illumination sheet 162 and the reinforcing portion 12, the switch mechanism relating to the second aspect of the fourth exemplary embodiment is identical the switch mechanisms relating to the first and the third exemplary embodiments. Further, the second exemplary embodiment may be combined therewith.

FIG. 25 shows a schematic partial cross-section for explaining the electrical connection between the reinforcing portion 12 and the illumination sheet 162. The illumination sheet 162 comprises the ground potential wiring 163 facing at least a part of the reinforcing portion 12 on a surface facing the reinforcing portion 12. In the mode shown in FIGS. 24 and 25, the reinforcing portion is provided between the illumination sheet 162 and the wiring board 5. The ground potential wiring 163 can be formed by pattern printing, for instance, Ag paste on a non-light emitting surface of the illumination sheet 162.

In the second aspect of the fourth exemplary embodiment, the reinforcing portion 12 is formed with a conductive material and is electrically connected to the ground potential wiring 163. The method for electrically connecting the ground potential wiring 163 and the reinforcing portion 12 is not limited to a particular one, and various methods can be suitably applied. For instance, the ground potential wiring 163 and the reinforcing portion 12 may be directly contacted each other, or as shown in FIGS. 24 and 25, they may be electrically connected via an electrically conductive adhesive 164.

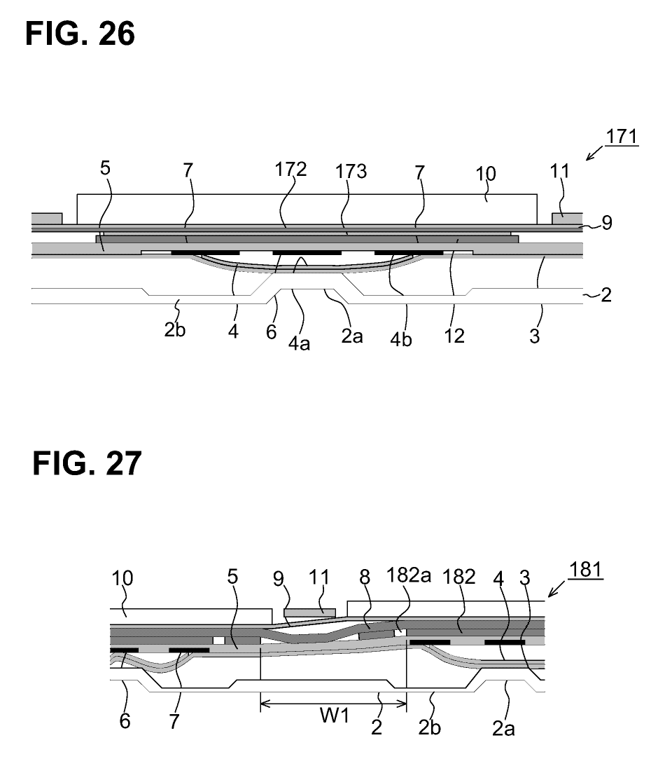

Next, a switch mechanism relating to a third aspect of the fourth exemplary embodiment of the present invention will be described. FIG. 26 shows a schematic partial cross-section of the switch mechanism relating to the third aspect of the fourth exemplary embodiment of the present invention. Note that, in FIG. 26, the same symbols are given to elements same as those in the first exemplary embodiment.

The switch mechanism 171 relating to the third aspect of the fourth exemplary embodiment does not comprise the illumination sheet. Further, the switch mechanism 171 comprises a ground potential wiring 172 underneath the thin sheet 9. The reinforcing portion 12 is electrically connected to the ground potential wiring 172. As a result, by electrically connecting the reinforcing portion 12 in an electrically floating state to the ground, the occurrence of ESD can be prevented and the reliability of the electronic device can be improved. Except for the fact that the illumination sheet is not provided, and the electrical connection between the reinforcing portion 12 and the ground potential wiring 172, the switch mechanism relating to the third aspect of the fourth exemplary embodiment is identical the switch mechanisms relating to the first and the third exemplary embodiments. Further, the second exemplary embodiment may be combined therewith.

The method for electrically connecting the ground potential wiring 172 and the reinforcing portion 12 is not limited to a particular one, and various methods can be suitably applied. For instance, the ground potential wiring 172 and the reinforcing portion 12 may be directly contacted each other, or as shown in FIG. 26, they may be electrically connected via an electrically conductive adhesive 173.

The fourth exemplary embodiment has been described with a combination of the first and the third exemplary embodiments as the basis, however, it can be applied to a combination of the second and the third exemplary embodiments as well. Further, the fourth exemplary embodiment can be applied to combinations of the first to the third exemplary embodiments.

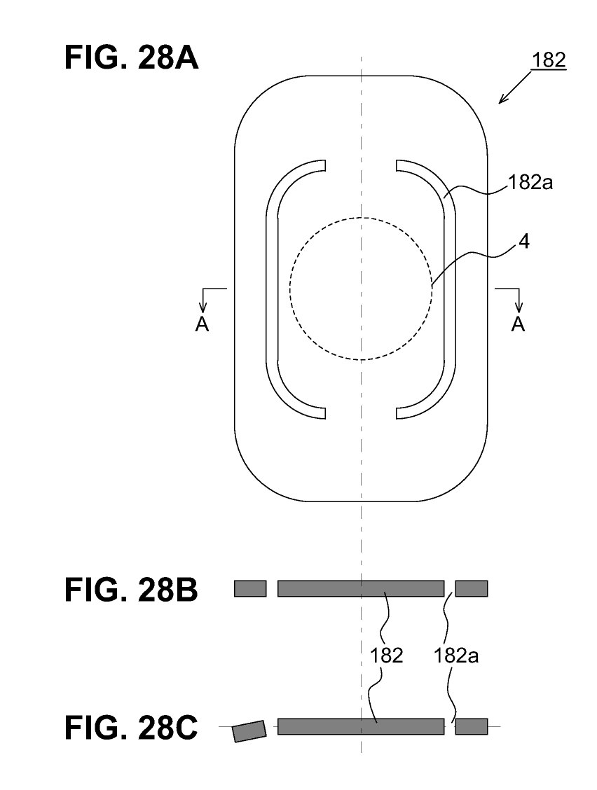

Next, a switch mechanism relating to a fifth exemplary embodiment of the present invention will be described. First, a switch mechanism relating to a first aspect of the fifth exemplary embodiment will be described. FIG. 27 shows a schematic partial cross-section of the switch mechanism relating to the first aspect of the fifth exemplary embodiment of the present invention. FIG. 27 is a schematic cross-section showing an area between adjacent switch buttons when one of the switch buttons is depressed. FIGS. 28A, 28B, and 28C show a schematic plan and schematic cross-sections of a reinforcing portion in the switch mechanism relating to the fifth exemplary embodiment of the present invention. FIG. 28A is a schematic cross-section of the reinforcing portion, FIGS. 28B and 28C are schematic cross-sections along line A-A in FIG. 28A. In FIG. 28A, a planar projection of the conductor 4 is indicated by a broken line. Further, in FIG. 27, the same symbols are given to elements same as those in the first exemplary embodiment.

Except for the reinforcing portion 182, the switch mechanism 181 relating to the fifth exemplary embodiment of the present invention is identical to the switch mechanism relating to the first and the third exemplary embodiments. Further, the present mode may be combined with at least one of the second and the fourth exemplary embodiments.

The reinforcing portion 182 comprises at least one deformation assisting portion 182a that facilitates the bending or reversible deformation of at least a part of the reinforcing portion 182. In the mode shown in FIGS. 28A, 28B, and 28C, the deformation assisting portion 182a is formed on a part of the reinforcing portion 182 along the contour of the reinforcing portion 182 as a slit-like through hole. The deformation assisting portion 182a is formed at a location where it does not overlap the conductor 4 in a planar projection so as to prevent excessive deformation of the conductor 4.

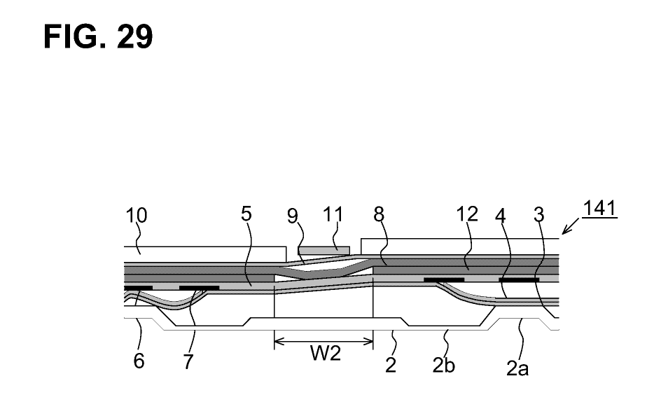

Next, the function of the deformation assisting portion 182a will be described. FIG. 29 shows a schematic cross-section of the switch mechanism relating to the third exemplary embodiment of the present invention without the deformation assisting portion. FIG. 29 is a schematic cross-section showing an area between adjacent switch buttons when one of the switch buttons is depressed, as FIG. 27. In the switch mechanism 181 in the first aspect of the fifth exemplary embodiment, when the switch button 10 (the switch button on the left side in FIG. 27) is depressed, a part or an end of the reinforcing portion 182, on the side of the depressed switch button, underneath the switch button 10 (the switch button on the right side in FIG. 27) adjacent to the depressed switch button 10 is partially bent because of the deformation assisting portion 182a, as shown in FIG. 28C. As a result, the region (area) of the wiring board 5 and the illumination sheet 8 bent when the switch button 10 is depressed can be larger, compared to the mode without the deformation assisting portion shown in FIG. 29. In other words, in the mode without the deformation assisting portion shown in FIG. 29, the region of the wiring board 5 and the other parts bent when the switch button 10 is depressed has a width W2 between adjacent reinforcing portions 12. On the other hand, in the mode relating to the present mode shown in FIG. 27, the region of the wiring board 5 and the other parts bent when the switch button 10 is depressed has a width W1 between the outer edge of the reinforcing portion 182 underneath the depressed switch button 10 and the deformation assisting portion 182a of the reinforcing portion 182 underneath the adjacent switch button. According to the present mode, since the bent region of the wiring board 5 and the other parts is enlarged, mutual influences between adjacent switch buttons can be reduced and a clearer sense of clicking can be obtained.

Since the part of the reinforcing portion 182 outside the deformation assisting portion 182a supports the switch button 10, the operator can more easily feel the presence of the switch button 10 (a sense of a button when the switch button 10 is depressed). For instance, the bent region of the wiring board 5 and the other parts can be enlarged even if the area of the reinforcing portion is reduced. However, in this case, it is more difficult for the operator to feel the presence of the switch button 10 since outer edge areas of the switch button 10 is not supported by the reinforcing portion 182. On the other hand, according to the present mode, moving the outer edge of the reinforcing portion 182 towards the outer edge of the switch button 10 allows the operator to feel the presence of the switch button 10 more easily.

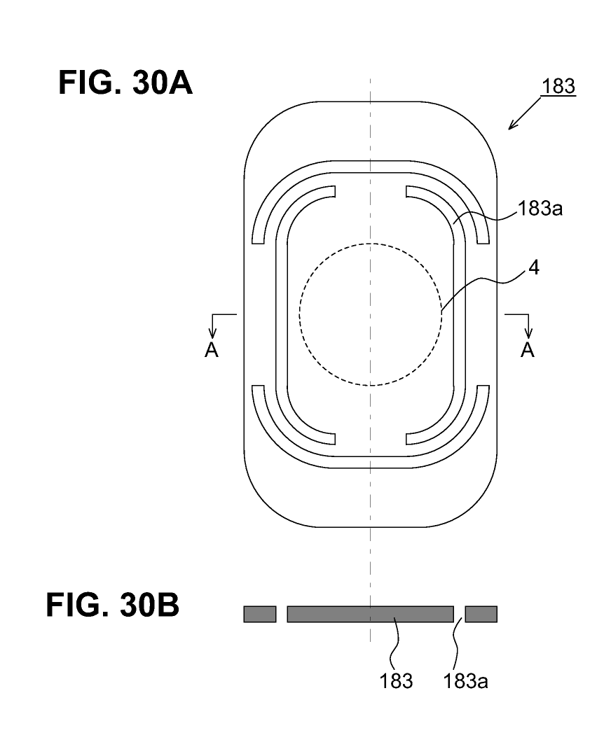

The shape, form and size of the deformation assisting portion can be suitably set as long as it facilitates the partial deformation or bending of the reinforcing portion. FIGS. 30 to 36 show schematic plans and cross-sections illustrating examples of the reinforcing portion having the deformation assisting portion. In FIGS. 30 to 34, FIG. A are schematic plans and FIG. B are schematic cross-sections along lines A-A in FIG. A.

Deformation assisting portions 183a of a reinforcing portion 183 shown in FIGS. 30A and 30B are slit-like through holes formed along the four sides of the reinforcing portion 183. The through holes are doubly formed on some parts of the reinforcing portion 183. This facilitates the bending of each side end.

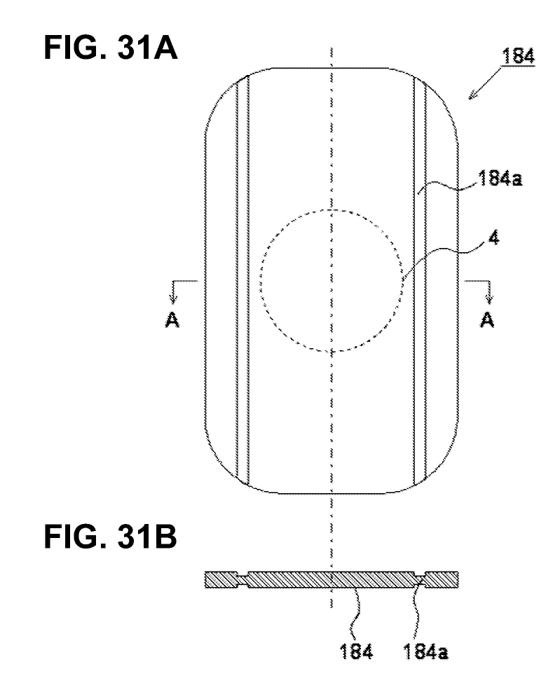

A deformation assisting portion 184a of a reinforcing portion 184 shown in FIGS. 31A and 31B is at least one groove formed along the sides of the reinforcing portion 184. In the mode shown in FIGS. 31A and 31B, the grooves are formed on both surfaces, and the thickness of the deformation assisting portion 184a is thinner than other parts.

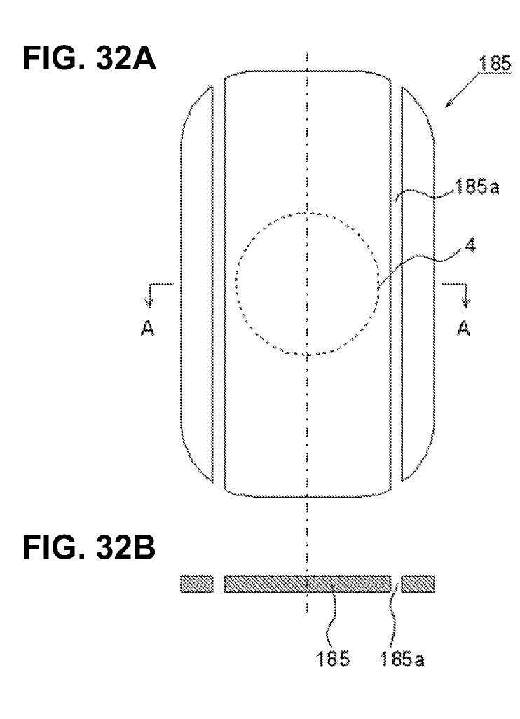

Deformation assisting portions 185a of a reinforcing portion 185 shown in FIGS. 32A and 32B are formed as gaps that fragment the reinforcing portion 185. In the mode shown in FIG. 32, the reinforcing portion 185 is divided into three pieces by the two areas of the deformation assisting portion 185a.

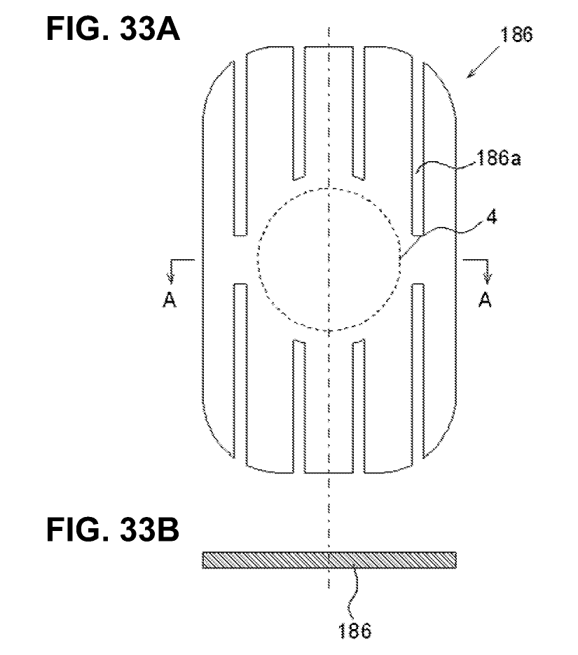

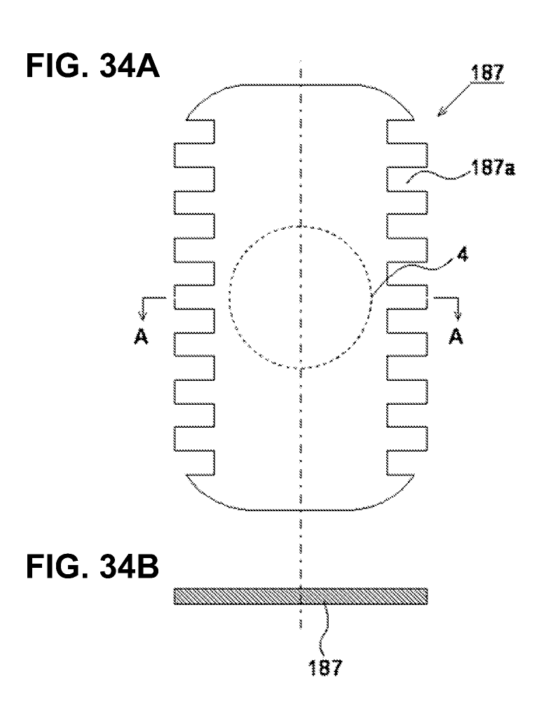

Deformation assisting portions 186a and 187a of reinforcing portions 186 and 187 shown in FIGS. 33 and 34 are at least one notch. In the modes shown in FIGS. 33 and 34, the notches are formed on two facing sides, however, they may be formed on four sides.

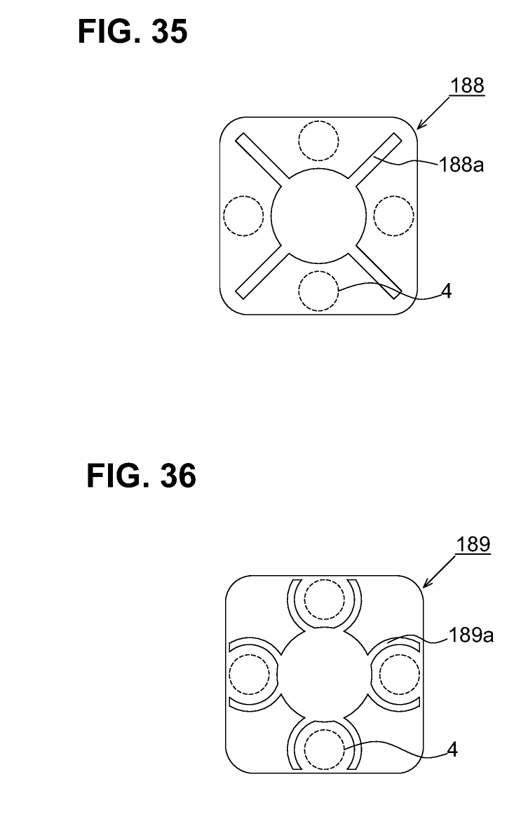

Reinforcing portions 188 and 189 shown in FIGS. 35 and 36 are provided underneath switch buttons having four direction keys (up/down/left/right) found on a mobile telephone device. The reinforcing portions 188 and 189 are provided above four conductors 4: up, down, left, and right. Deformation assisting portions 188a and 189a are formed between adjacent conductors 4. In the reinforcing portion 188 shown in FIG. 35, the deformation assisting portion 188a is formed as a radial (cross) notch (through hole) extending between adjacent conductors 4. In the reinforcing portion 189 shown in FIG. 36, the deformation assisting portion 189a is formed as an arcuate notch (through hole) along the contours of the conductors 4.

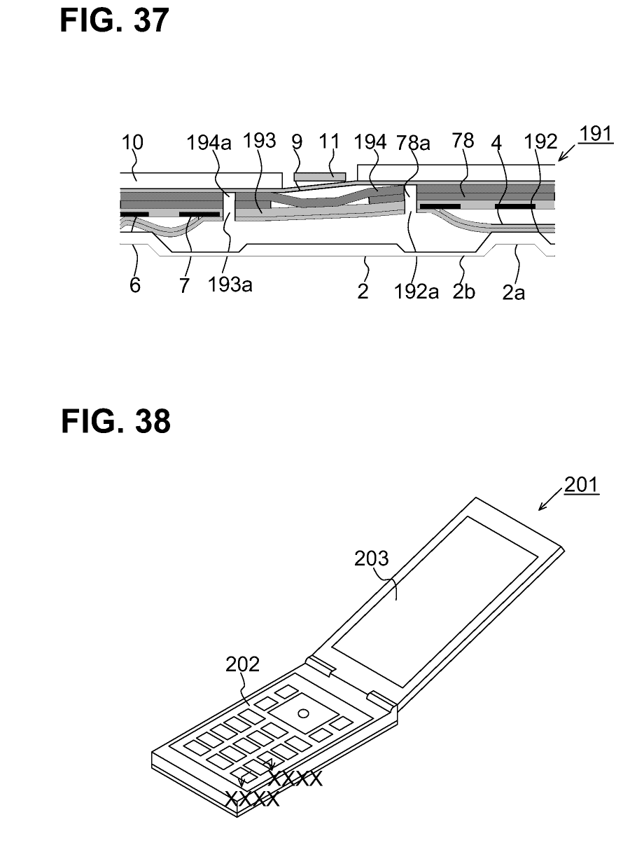

Next, a switch mechanism relating to a second aspect of the fifth exemplary embodiment of the present invention will be described. FIG. 37 shows a schematic partial cross-section of the switch mechanism relating to the second aspect of the fifth exemplary embodiment of the present invention. FIG. 37 is a schematic cross-section showing an area between adjacent switch buttons when one of the switch buttons is depressed. In the first aspect of the fifth exemplary embodiment, the deformation assisting portion is formed only on the reinforcing portion, however, the deformation assisting portions are formed on the other parts in the second aspect of the fifth exemplary embodiment.

For instance, a deformation assisting portion that facilitates the bending or deformation of at least one out of an adhesive sheet 192, a wiring board 193, and an illumination sheet 194 can be formed. In the mode shown in FIG. 37, through-hole type deformation assisting portions 192a, 193a, and 194a are formed on the adhesive sheet 192, the wiring board 193, and the illumination sheet 194 respectively. The deformation assisting portions 192a, 193a, and 194a may be of the thin-thickness type. Further, it is preferable that the deformation assisting portion of each part be disposed so as to at least partially overlap. For instance, in the mode shown in FIG. 37, the deformation assisting portion 194a of the illumination sheet 194, a deformation assisting portion 78a of a reinforcing portion 78, the deformation assisting portion 193a of the wiring board 193, and the deformation assisting portion 192a of the adhesive sheet 192 are disposed so as to overlap, i.e., to have the through holes connected. As a result, the wiring board 193 and the other parts are more easily bent when the switch button 10 is depressed.

The switch mechanism relating to the second aspect of the fifth exemplary embodiment of the present invention is identical to the switch mechanism relating to the first aspect of the fifth exemplary embodiment, except for the forms of the wiring board and the other parts. Further, at least one mode out of the second and the fourth exemplary embodiments may be combined with the present aspect.

The fifth exemplary embodiment has been described with a combination of the first and the third exemplary embodiments as the basis, however, it can be applied to any combination of the second to the fourth exemplary embodiments as well.

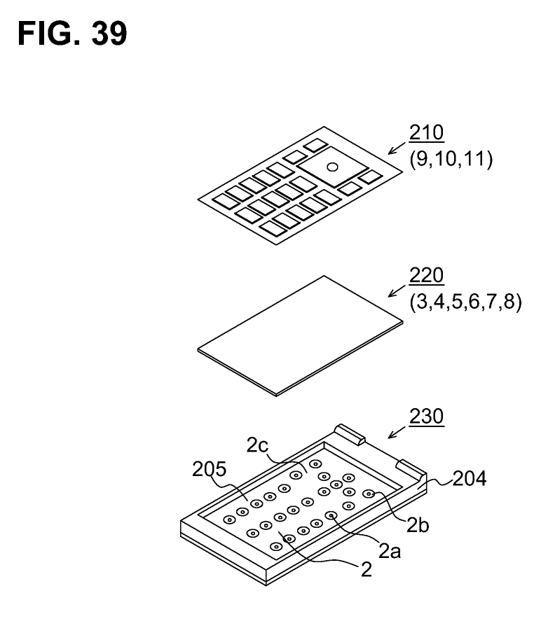

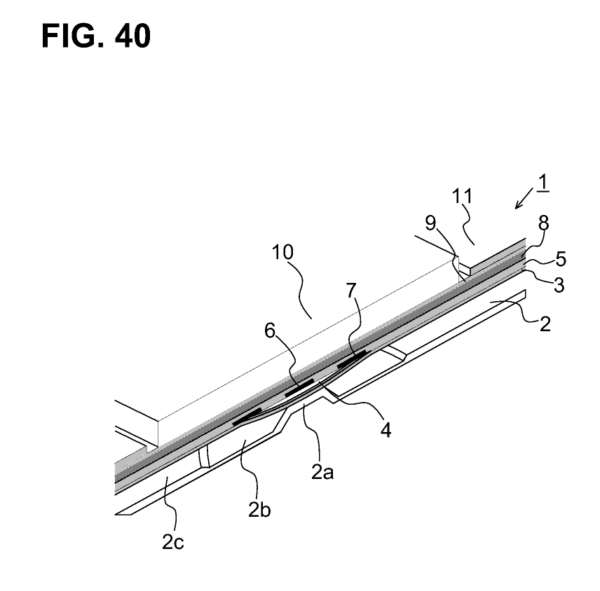

Next, an electronic device relating to a sixth exemplary embodiment of the present invention will be described. FIG. 38 shows a schematic perspective of the electronic device relating to the sixth exemplary embodiment of the present invention. In the present mode, the electronic device of the present invention will be described using a mobile telephone device as an example of the electronic device. The electronic device 201 shown in FIG. 38 is a foldable mobile telephone and comprises an operation section 202 and a display 203. FIG. 39 shows a schematic partial disassembly perspective of the operation section of the mobile telephone device shown in FIG. 38. Further, FIG. 40 shows a schematic partial cross-section of a part of the switch mechanism along line XXXX-XXXX in FIG. 38.

The operation section 202 comprises the switch mechanism of the present invention. FIGS. 39 and 40 show an example in which the switch mechanism relating to the first exemplary embodiment shown in FIGS. 1 and 2 is applied. As shown in FIG. 39, the operation section 202 is formed by laminating a switch unit 210 (the thin sheet 9, the switch button 10, and the cover portion 11), a wiring board unit 220 (the adhesive sheet 3, the conductor 4, the wiring board 5, and the illumination sheet 8), and a case unit 230 (an external case 204 and an internal case 205). The case unit 230 comprises the external case 204 and the internal case 205 housing internal parts such as the switch mechanism. The supporting plate in the switch mechanism of the present invention corresponds to the bottom surface of the internal case 205. In other words, inside the internal case 205, a plurality of the protruding sections 2a and the thin portions 2b are formed. Each protruding section 2a and thin portion 2b is formed so as to correspond to the location of the switch button 10. By using a part of the internal case 205 as the supporting plate 2, it is possible to mitigate large deformation of the supporting plate 2 as a whole even when each thin portion 2b is bent upon the depression of the switch button 10. It is preferable that the internal case 205 be formed with stainless steel.

According to the present invention, it becomes possible to integrally treat the illumination sheet 8, the wiring board 5, the conductor 4, and the adhesive sheet 3 as the wiring board unit, the internal structure of the electronic device 201 becomes simple, and the manufacturing of the electronic device 201 is facilitated.

The electronic device of the present invention has been described using an example of the electronic device comprising the switch mechanism relating to the first exemplary embodiment of the present invention, however, without being limited to this, any mode of the switch mechanism of the present invention can be applied to the electronic device of the present invention.

### Example 1

In order to investigate the durability of the switch button in the switch mechanism of the present invention, a typing test was conducted. An object that depressed the switch button was a columnar pressurization material, which looked like a human finger, formed with an elastic body such as a rubber material having a diameter of φ 5 mm to φ 10 mm (an amount to cover the entire surface of a switch button), and the test was conducted by having the switch button repeatedly depressed. The shape and form of the supporting plate in this example were the same as those in the first exemplary embodiment, and the outer circumference of the thin portion was molded so that the thin portion had a diameter of φ 4 mm, compared to a φ 3 mm diameter of the conductor. The material of the supporting plate was stainless steel, and the test was respectively conducted with two different thicknesses of the thin portion: 0.2 mm (Subject 1) and 0.1 mm (Subject 2), compared to the thickness (0.3 mm) of the thick portion. Further, as a comparative example, the same test was conducted with a supporting plate having no thin portion formed thereon as shown in FIG. 41 (i.e., a supporting plate having a thickness of 0.3 mm in the regions corresponding to the thin portion). Table 1 shows the test results. The results shown in the First Test Conditions are the results from a typing test conducted with the weight of keystrokes set to that of normal use. The results shown in the Second Test Conditions are the results from a typing test conducted with the weight of keystrokes set larger than that of normal use.

In the First Test Conditions, while a crack occurred in the switch button of the switch mechanism without the thin portion (the thickness of the thin portion is 0.3 mm) after keystrokes of 28,000, in the switch buttons of the switch mechanisms of the present invention having the thin portion, a crack occurred in the switch mechanism of Subject 1 with the thin portion having a thickness of 0.2 mm after keystrokes of 35,000 and no crack occurred in the switch mechanism of Subject 2 with the thin portion having a thickness of 0.1 mm even after keystrokes of 50,000. Therefore, it is confirmed that the switch button has a life longer by 1.25 times in Subject 1 with the thin portion having a thickness of 0.2 mm and it has a life longer by 1.8 times or more in Subject 2 with the thin portion having a thickness of 0.1 mm, compared to the comparative example without the thin portion.

Meanwhile, in the Second Test Conditions where the applied weight is larger than in the First Test Conditions, while a crack occurred in the switch mechanism without the thin portion after keystrokes of 2,000, no crack was found on the switch button of the switch mechanism of Subject 2 with the thin portion having a thickness of 0.1 mm even after repeated keystrokes of 20,000 or more. Therefore, it is confirmed that the switch button has a life longer by 10 times or more in Subject 2, compared to the comparative example without the thin portion.

As a result, it is confirmed that the life of the switch button can be prolonged by forming the thin portion and displacing the protruding section downward when the switch button is depressed.

TABLE 1

| | Subject 1 | Subject 2 | Comparative Example |
|---|---|---|---|
| Thin portion | 0.2 | 0.1 | 0.3 (no thin portion) |
| thickness/mm | | | |
| First Test | 35,000 | 50,000 or more | 28,000 |
| Conditions | | | |
| Second Test | — | 20,000 or more | 2,000 or less |
| Conditions | | | |

The switch mechanism of the present invention has been described based on the modes above, however, the present invention is not limited to the modes described above, and the present invention can include various modifications, changes, and improvements within the scope of the present invention and based on the basic technological ideas of the present invention applied thereto. Further, within the scope of the claims of the present invention, various combinations, substitutions, and selections of the disclosed elements are possible.

Other objects, purposes and developments of the present invention will become apparent in the entire disclosure of the present invention including the claims.

### INDUSTRIAL APPLICABILITY

In the above modes, the descriptions are made using a mobile telephone device as an example of an electronic device to which the switch mechanism of the present invention is applied, however, electronic devices to which the switch mechanism of the present invention can be applied are not limited to mobile telephones, and it can be applied to various electronic devices such as PDAs (Personal Digital Assistants/Personal Data Assistants), portable audio devices, and various remote controllers.

Further, each disclosure of Patent Documents above is incorporated herein by reference thereto. It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

### EXPLANATION OF SYMBOLS

1, 81, 141, 151, 161, 171, 181, 191: switch mechanism
2, 22, 32, 42, 52, 62, 72, 82: supporting plate
2a, 22a, 32a, 42a, 52a, 62a, 72a, 82a, 92a, 102a, 112a, 122a: protruding section
2b, 22b, 32b, 42b, 52b, 62b, 72b, 82b, 92b, 102b, 112b, 122b: thin portion
2c, 22c, 32c, 42c, 52c, 62c, 72c, 82c: thick portion
82d, 92d, 102d, 112d, 122d: through hole
3, 192: adhesive sheet
4: conductor
4a: center part
4b: periphery
5, 152, 193: wiring board
6, 154: first electrode
7, 155: second electrode
8, 162, 194: illumination sheet
9: thin sheet
10: switch button
11: cover portion
12, 159, 160, 182, 183, 184, 185, 186, 187, 188, 189: reinforcing portion
153: substrate
153a: through hole
156: ground electrode
157: insulating layer
158, 164, 173: electrically conductive adhesive
163, 172: ground potential wiring
159a: concave portion
160a: protrusion
182a, 183a, 184a, 185a, 186a, 187a, 188a, 189a: deformation assisting portion
192a: deformation assisting portion
193a: deformation assisting portion
194a: deformation assisting portion
201: electronic device
202: operation section
203: display
204: external case
205: internal case
210: switch unit
220: wiring board unit
230: case unit
401: switch mechanism
402: supporting plate
402a: protruding section
403: adhesive sheet
404: conductor
405: wiring board
406: first electrode
407: second electrode
408: illumination sheet
409: thin sheet
410: switch button
411: cover portion

1.-30. (canceled)

31. A switch mechanism comprising:
a switch button(s) receiving a depressing operation;
a supporting plate having a protruding section at a location corresponding to said switch button; and
a switching structure disposed between said switch button and said supporting plate and whose electrical conduction state is switched by said protruding section in a state where said switch button is depressed; wherein
said protruding section is displaced in a direction in which said switch button is depressed in the state where said switch button is depressed.

32. The switch mechanism as defined in claim 31, wherein
said switching structure comprises a wiring board having a first electrode and a second electrode on one surface and a conductor disposed facing said one surface of said wiring board; and
said conductor does not electrically connect said first and said second electrodes in a non-depressed state of said switch button and electrically connect said first and said second electrodes by being supported by said protruding section in a depressed state of said switch button.

33. The switch mechanism as defined in claim 31, wherein the displacement of said protruding section is restored when the depressed state of said switch button is cancelled.

34. The switch mechanism as defined in claim 31, wherein said protruding section is displaced by 0.05 mm to 0.15 mm in the direction in which said switch button is depressed in the depressed state of said switch button.

35. The switch mechanism as defined in claim 31, wherein said supporting plate comprises a thin portion, having a thickness thinner than other region(s), formed so as to be bent in the depressed state of said switch button in at least one region surrounding said protruding section.

36. The switch mechanism as defined in claim 35, wherein said thin portion is formed adjacent to said protruding section and surrounding said protruding section.

37. The switch mechanism as defined in claim 35, wherein said thin portion is formed surrounding said protruding section without being adjacent to said protruding section.

38. The switch mechanism as defined in claim 35, wherein said thin portion comprises at least one through hole.

39. The switch mechanism as defined in claim 35, wherein said supporting plate is made of stainless steel and said thin portion has a thickness of is 0.1 mm to 0.2 mm.

40. The switch mechanism as defined in claim 35, wherein
said conductor is dish-shaped and its concave portion faces said wiring board; and
said conductor contacts said first electrode by having a part of said concave portion of said conductor elevated in a direction of said wiring board due to pressure from said protruding section in the depressed state of said switch button.

41. The switch mechanism as defined in claim 35, wherein said switch button is made of resin.

42. An electronic device comprising a switch mechanism; wherein
said switch mechanism comprises: a switch button receiving a depressing operation, a supporting plate having a protruding section at a location(s) corresponding to said switch button, and a switching structure disposed between said switch button and said supporting plate and whose electrical conduction state is switched by said protruding section in a state where said switch button is depressed; and
said protruding section is displaced in a direction in which said switch button is depressed in the state where said switch button is depressed.

43. The electronic device as defined in claim 42, wherein
said switching structure comprises a wiring board having a first electrode and a second electrode on one surface and a conductor disposed facing said one surface of said wiring board; and
said conductor does not electrically connect said first and said second electrodes in a non-depressed state of said switch button, and electrically connect said first and said second electrodes by being supported by said protruding section in the depressed state of said switch button.

44. The electronic device as defined in claim 42, wherein said supporting plate is a part of a case housing internal parts of the electronic device.

45. The electronic device as defined in claim 42, wherein said supporting plate comprises a thin portion, having a thickness thinner than other regions, formed so as to be bent in the depressed state of said switch button in at least one region surrounding said protruding section.

46. The electronic device as defined in claim 45, wherein said thin portion comprises at least one through hole.

47. The switch mechanism as defined in claim 32, wherein the displacement of said protruding section is restored when the depressed state of said switch button is cancelled.

48. The switch mechanism as defined in claim 32, wherein said protruding section is displaced by 0.05 mm to 0.15 mm in the direction in which said switch button is depressed in the depressed state of said switch button.

49. The switch mechanism as defined in claim 33, wherein said protruding section is displaced by 0.05 mm to 0.15 mm in the direction in which said switch button is depressed in the depressed state of said switch button.

50. The switch mechanism as defined in claim 32, wherein said supporting plate comprises a thin portion, having a thickness thinner than other region(s), formed so as to be bent in the depressed state of said switch button in at least one region surrounding said protruding section.
